(19) United States
(12) Patent Application Publication
(10) Pub. No.: US 2024/0023085 A1
(43) Pub. Date: Jan. 18, 2024

(54) METHOD AND APPARATUS OF UE CHANNEL OCCUPANCY SHARING WITH SIDELINK

(71) Applicant: Samsung Electronics Co., Ltd., Suwon-si (KR)

(72) Inventors: Hongbo Si, Plano, TX (US); Emad N. Farag, Flanders, NJ (US)

(21) Appl. No.: 17/812,707

(22) Filed: Jul. 14, 2022

(51) Int. Cl. H04W 72/12; H04W 74/08

(52) U.S. Cl. CPC H04W 72/1263; H04W 74/0833; H04W 72/121

(57) ABSTRACT

Apparatuses and methods for a user equipment (UE) channel occupancy sharing with a sidelink in a wireless communication system. A method of a UE includes performing a channel access procedure to initiate a channel occupancy on a channel with shared spectrum channel access and determining that the channel occupancy is to be shared with at least one other UE. The method further includes transmitting a first sidelink transmission within the channel occupancy and receiving, from the at least one other UE, a second sidelink transmission within the channel occupancy after transmitting the first sidelink transmission within the channel occupancy.

CROSS-REFERENCE TO RELATED APPLICATIONS AND CLAIM OF PRIORITY

The present application claims priority to U.S. Provisional Patent Application No. 63/227,852, filed on Jul. 30, 2021. The content of the above-identified patent document is incorporated herein by reference.

### TECHNICAL FIELD

The present disclosure relates generally to wireless communication systems and, more specifically, the present disclosure relates to user equipment (UE) channel occupancy sharing with a sidelink (SL) in a wireless communication system.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

The present disclosure relates to wireless communication systems and, more specifically, the present disclosure relates to UE channel occupancy sharing with a SL in a wireless communication system.

In one embodiment, a UE in a wireless communication system is provided. The UE includes a processor configured to perform a channel access procedure to initiate a channel occupancy on a channel with shared spectrum channel access and determine that the channel occupancy is to be shared with at least one other UE. The UE further includes a transceiver operably coupled to the processor. The transceiver is configured to transmit a first sidelink transmission within the channel occupancy and receive, from the at least one other UE, a second sidelink transmission within the channel occupancy after transmitting the first sidelink transmission.

In another embodiment, a method of a UE in a wireless communication system is provided. The method includes performing a channel access procedure to initiate a channel occupancy on a channel with shared spectrum channel access and determining that the channel occupancy is to be shared with at least one other UE. The method further includes transmitting a first sidelink transmission within the channel occupancy and receiving, from the at least one other UE, a second sidelink transmission within the channel occupancy after transmitting the first sidelink transmission within the channel occupancy.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example of wireless network according to various embodiments of the present disclosure;

FIG. 2 illustrates an example of gNB according to various embodiments of the present disclosure;

FIG. 3 illustrates an example of UE according to various embodiments of the present disclosure;

FIGS. 4 and 5 illustrate an example of wireless transmit and receive paths according to various embodiments of the present disclosure;

FIG. 6 illustrates an example of Type 1 downlink (DL)/uplink (UL) channel access procedure according to various embodiments of the present disclosure;

FIG. 7 illustrates an example of channel occupancy (CO) sharing between two UEs with SL transmissions only according to various embodiments of the present disclosure;

FIG. 8 illustrates an example of CO sharing among multiple UEs with the same initiating device according to various embodiments of the present disclosure;

FIG. 9 illustrates an example of CO sharing among multiple UEs with the different initiating devices according to various embodiments of the present disclosure;

FIG. 10 illustrates an example of CO sharing between parallel sidelink transmissions according to various embodiments of the present disclosure;

FIG. 11 illustrates an example of CO sharing between SL and UL according to various embodiments of the present disclosure;

FIG. 12 illustrates an example of CO sharing between SL and DL according to various embodiments of the present disclosure;

FIG. 13 illustrates an example of CO sharing among SL, UL, and DL according to various embodiments of the present disclosure; and

FIG. 14 illustrates an example method for UE channel occupancy sharing with a SL in a wireless communication system according to embodiments of the present disclosure.

### DETAILED DESCRIPTION

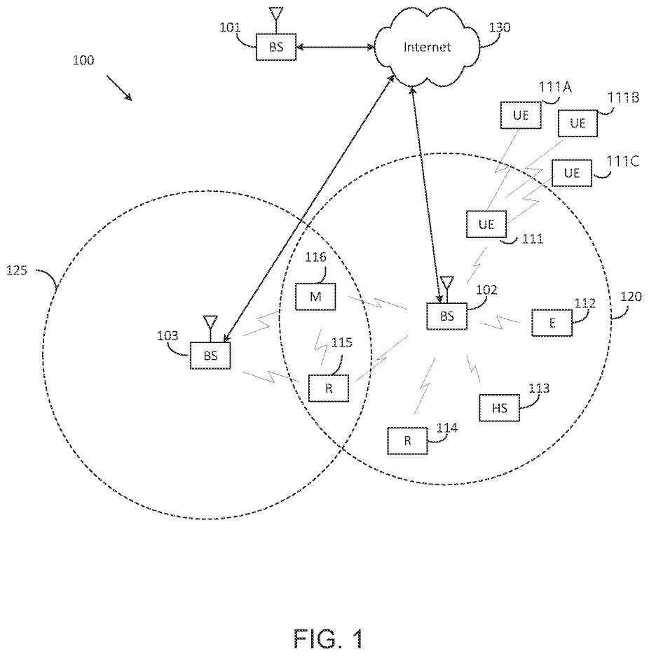

FIG. 1 through FIG. 14, discussed below, and the various embodiments used to describe the principles of the present disclosure in this patent document are by way of illustration only and should not be construed in any way to limit the scope of the present disclosure. Those skilled in the art will understand that the principles of the present disclosure may be implemented in any suitably arranged system or device.

The following documents are hereby incorporated by reference into the present disclosure as if fully set forth herein: 3GPP TS 38.211 v.16.6.0, “Physical channels and modulation”; 3GPP TS 38.212 v.16.6.0, “Multiplexing and channel coding”; 3GPP TS 38.213 v16.6.0, “NR; Physical Layer Procedures for Control”; 3GPP TS 38.214: v.16.6.0, “Physical layer procedures for data”; and 3GPP TS 38.331 v.16.5.0, “Radio Resource Control (RRC) protocol specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably-arranged communications system.

FIG. 1 illustrates an example of wireless network according to embodiments of the present disclosure. The embodiment of the wireless network shown in FIG. 1 is for illustration only. Other embodiments of the wireless network 100 could be used without departing from the scope of this present disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of UEs within a coverage area 120 of the gNB 102. The first plurality of UEs includes a UE 111, which may be located in a small business; a UE 112, which may be located in an enterprise (E); a UE 113, which may be located in a WiFi hotspot (HS); a UE 114, which may be located in a first residence (R); a UE 115, which may be located in a second residence (R); and a UE 116, which may be a mobile device (M), such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In various embodiments, a UE 116 may communicate with another UE 115 via a sidelink (SL). For example, both UEs 115-116 can be within network coverage (of the same or different base stations). In another example, the UE 116 may be within network coverage and the other UE may be outside network coverage (e.g., UEs 111A-111C). In yet another example, both UE are outside network coverage. In some embodiments, one or more of the gNBs 101-103 may communicate with each other and with the UEs 111-116 using 5G/NR, LTE, LTE-A, WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for a UE's channel occupancy sharing with a SL in a wireless communication system. In certain embodiments, and one or more of the gNBs 101-103 includes circuitry, programing, or a combination thereof, for a UE's channel occupancy sharing with a SL in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs (e.g., via a Uu interface or air interface, which is an interface between a UE and 5G radio access network (RAN)) and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

As discussed in greater detail below, the wireless network 100 may have communications facilitated via one or more devices (e.g., UE 111A to 111C) that may have a SL communication with the UE 111. The UE 111 can communicate directly with the UEs 111A to 111C through a set of SLs (e.g., SL interfaces) to provide sideline communication, for example, in situations where the UEs 111A to 111C are remotely located or otherwise in need of facilitation for network access connections (e.g., BS 102) beyond or in addition to traditional fronthaul and/or backhaul connections/interfaces. In one example, the UE 111 can have direct communication, through the SL communication, with UEs 111A to 111C with or without support by the BS 102. Various of the UEs (e.g., as depicted by UEs 112 to 116) may be capable of one or more communication with their other UEs (such as UEs 111A to 111C as for UE 111).

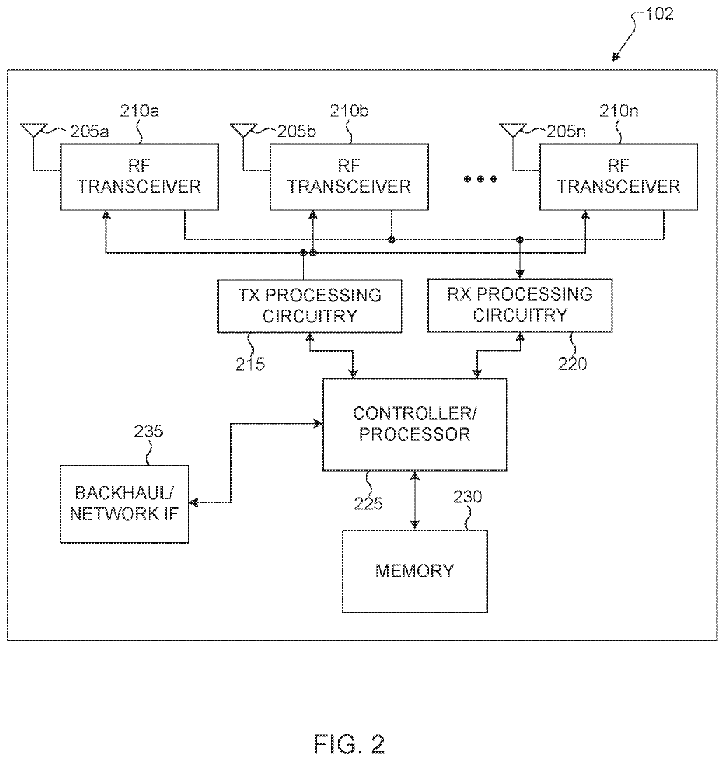

FIG. 2 illustrates an example of gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this present disclosure to any particular implementation of a gNB.

As shown in FIG. 2, the gNB 102 includes multiple antennas 205a-205n, multiple RF transceivers 210a-210n, transmit (TX) processing circuitry 215, and receive (RX) processing circuitry 220. The gNB 102 also includes a controller/processor 225, a memory 230, and a backhaul or network interface 235.

The RF transceivers 210a-210n receive, from the antennas 205a-205n, incoming RF signals, such as signals transmitted by UEs in the network 100. The RF transceivers 210a-210n down-convert the incoming RF signals to generate IF or baseband signals. The IF or baseband signals are sent to the RX processing circuitry 220, which generates processed baseband signals by filtering, decoding, and/or digitizing the baseband or IF signals. The RX processing circuitry 220 transmits the processed baseband signals to the controller/processor 225 for further processing.

The TX processing circuitry 215 receives analog or digital data (such as voice data, web data, e-mail, or interactive video game data) from the controller/processor 225. The TX processing circuitry 215 encodes, multiplexes, and/or digitizes the outgoing baseband data to generate processed baseband or IF signals. The RF transceivers 210a-210n receive the outgoing processed baseband or IF signals from the TX processing circuitry 215 and up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink channel signals and the transmission of downlink channel signals by the RF transceivers 210a-210n, the RX processing circuitry 220, and the TX processing circuitry 215 in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as an OS. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or RF transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. As a particular example, an access point could include a number of interfaces 235, and the controller/processor 225 could support a UE's channel occupancy sharing with a SL in a wireless communication system. As another particular example, while shown as including a single instance of TX processing circuitry 215 and a single instance of RX processing circuitry 220, the gNB 102 could include multiple instances of each (such as one per RF transceiver). Also, various components in FIG. 2 could be combined, further subdivided, or omitted and additional components could be added according to particular needs.

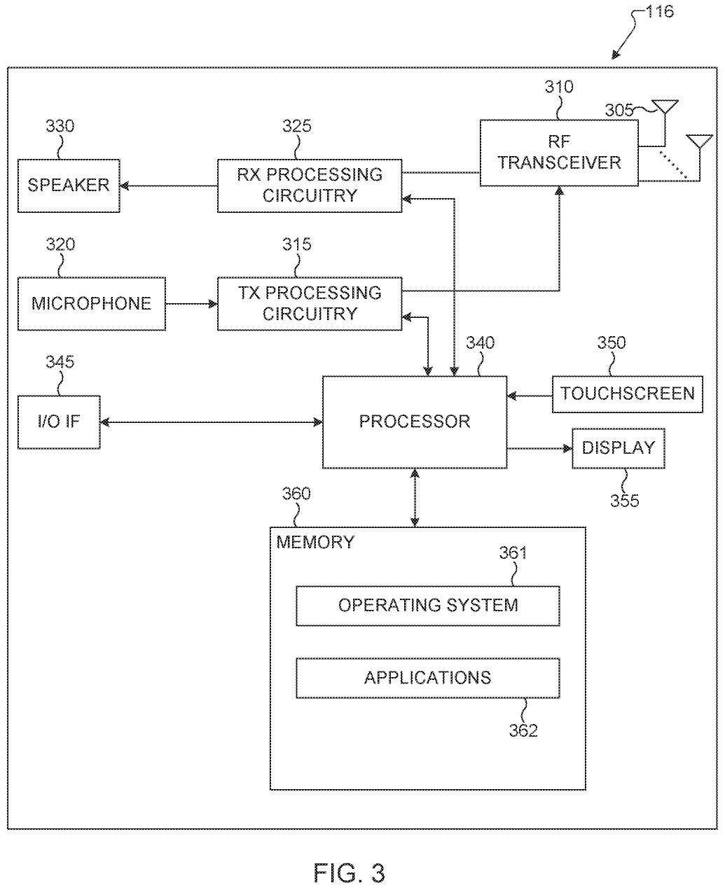

FIG. 3 illustrates an example of UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this present disclosure to any particular implementation of a UE.

As shown in FIG. 3, the UE 116 includes an antenna 305, a radio frequency (RF) transceiver 310, TX processing circuitry 315, a microphone 320, and receive (RX) processing circuitry 325. The UE 116 also includes a speaker 330, a processor 340, an input/output (I/O) interface (IF) 345, a touchscreen 350, a display 355, and a memory 360. The memory 360 includes an operating system (OS) 361 and one or more applications 362.

The RF transceiver 310 receives, from the antenna 305, an incoming RF signal transmitted by a gNB of the network 100 or by other UEs (e.g., one or more of UEs 111-115) on a SL channel. The RF transceiver 310 down-converts the incoming RF signal to generate an intermediate frequency (IF) or baseband signal. The IF or baseband signal is sent to the RX processing circuitry 325, which generates a processed baseband signal by filtering, decoding, and/or digitizing the baseband or IF signal. The RX processing circuitry 325 transmits the processed baseband signal to the speaker 330 (such as for voice data) or to the processor 340 for further processing (such as for web browsing data).

The TX processing circuitry 315 receives analog or digital voice data from the microphone 320 or other outgoing baseband data (such as web data, e-mail, or interactive video game data) from the processor 340. The TX processing circuitry 315 encodes, multiplexes, and/or digitizes the outgoing baseband data to generate a processed baseband or IF signal. The RF transceiver 310 receives the outgoing processed baseband or IF signal from the TX processing circuitry 315 and up-converts the baseband or IF signal to an RF signal that is transmitted via the antenna 305.

The processor 340 can include one or more processors or other processing devices and execute the OS 361 stored in the memory 360 in order to control the overall operation of the UE 116. For example, the processor 340 could control the reception of downlink and/or sidelink channel signals and the transmission of uplink and/or sidelink channel signals by the RF transceiver 310, the RX processing circuitry 325, and the TX processing circuitry 315 in accordance with well-known principles. In some embodiments, the processor 340 includes at least one microprocessor or microcontroller.

The processor 340 is also capable of executing other processes and programs resident in the memory 360, such as processes for a UE's channel occupancy sharing with a SL in a wireless communication system. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the touchscreen 350 and the display 355. The operator of the UE 116 can use the touchscreen 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). Also, while FIG. 3 illustrates the UE 116 configured as a mobile telephone or smartphone, UEs could be configured to operate as other types of mobile or stationary devices.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

A communication system includes a downlink (DL) that refers to transmissions from a base station or one or more transmission points to UEs and an uplink (UL) that refers to transmissions from UEs to a base station or to one or more reception points and a sidelink (SL) that refers to transmissions from one or more UEs to one or more UEs.

A time unit for DL signaling or for UL signaling on a cell is referred to as a slot and can include one or more symbols. A symbol can also serve as an additional time unit. A frequency (or bandwidth (BW)) unit is referred to as a resource block (RB). One RB includes a number of sub-carriers (SCs). For example, a slot can have duration of 0.5 milliseconds or 1 millisecond, include 14 symbols and an RB can include 12 SCs with inter-SC spacing of 30 KHz or 15 KHz, and so on.

DL signals include data signals conveying information content, control signals conveying DL control information (DCI), and reference signals (RS) that are also known as pilot signals. A gNB transmits data information or DCI through respective physical DL shared channels (PDSCHs) or physical DL control channels (PDCCHs). A PDSCH or a PDCCH can be transmitted over a variable number of slot symbols including one slot symbol. For brevity, a DCI format scheduling a PDSCH reception by a UE is referred to as a DL DCI format and a DCI format scheduling a physical uplink shared channel (PUSCH) transmission from a UE is referred to as an UL DCI format.

A gNB transmits one or more of multiple types of RS including channel state information RS (CSI-RS) and demodulation RS (DMRS). A CSI-RS is primarily intended for UEs to perform measurements and provide CSI to a gNB. For channel measurement, non-zero power CSI-RS (NZP CSI-RS) resources are used. For interference measurement reports (IMRs), CSI interference measurement (CSI-IM) resources associated with a zero power CSI-RS (ZP CSI-RS) configuration are used. A CSI process includes NZP CSI-RS and CSI-IM resources.

A UE can determine CSI-RS transmission parameters through DL control signaling or higher layer signaling, such as radio resource control (RRC) signaling, from a gNB. Transmission instances of a CSI-RS can be indicated by DL control signaling or be configured by higher layer signaling. A DMRS is transmitted only in the BW of a respective PDCCH or PDSCH and a UE can use the DMRS to demodulate data or control information.

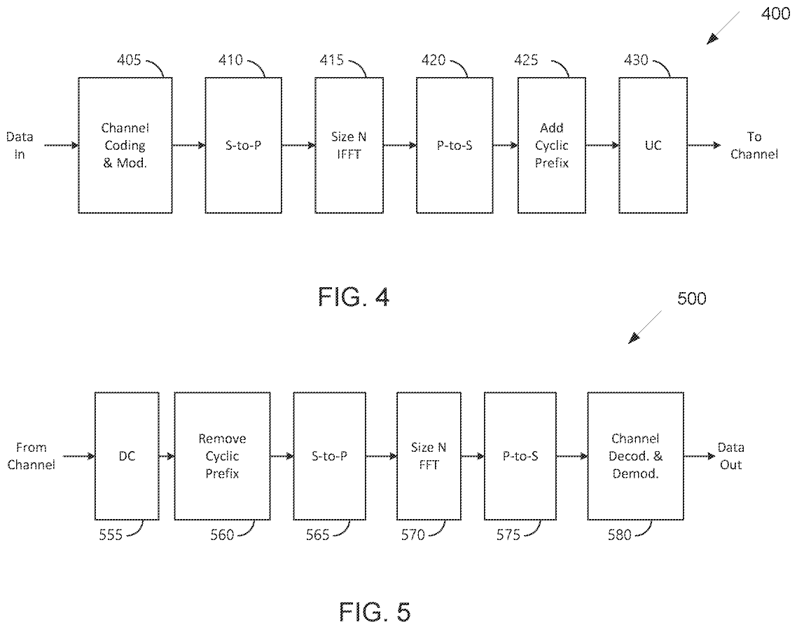

FIG. 4 and FIG. 5 illustrate examples of wireless transmit and receive paths according to this present disclosure. In the following description, a transmit path 400 may be described as being implemented in a gNB (such as the gNB 102), while a receive path 500 may be described as being implemented in a UE (such as a UE 116). However, it may be understood that the receive path 500 can be implemented in a gNB and that the transmit path 400 can be implemented in a UE. It may also be understood that the receive path 500 can be implemented in a first UE and that the transmit path 400 can be implemented in a second UE to support SL communications. In some embodiments, the receive path 500 is configured to support SL measurements in V2X communication as described in embodiments of the present disclosure.

The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a down-converter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols.

The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116.

As illustrated in FIG. 5, the down-converter 555 down-converts the received signal to a baseband frequency, and the remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the gNBs 101-103 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the gNBs 101-103 and/or transmitting in the sidelink to another UE and may implement the receive path 500 for receiving in the downlink from the gNBs 101-103 and/or receiving in the sidelink from another UE.

Each of the components in FIG. 4 and FIG. 5 can be implemented using only hardware or using a combination of hardware and software/firmware. As a particular example, at least some of the components in FIGS. 4 and FIG. 5 may be implemented in software, while other components may be implemented by configurable hardware or a mixture of software and configurable hardware. For instance, the FFT block 570 and the IFFT block 515 may be implemented as configurable software algorithms, where the value of size N may be modified according to the implementation.

Furthermore, although described as using FFT and IFFT, this is by way of illustration only and may not be construed to limit the scope of this present disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIGURE are meant to illustrate examples of the types of transmit and receive paths that can be used in a wireless network. Any other suitable architectures can be used to support wireless communications in a wireless network.

In Rel-16 new radio on unlicensed spectrum (NR-U), a node (gNB or UE) can initialize a channel occupancy on an operating channel after performing a channel access procedure, wherein the channel access procedure includes at least one sensing slot and the sensing is based on energy detection. In particular, for a single carrier channel access with dynamic channel access (or load-based-equipment (LBE) mode), a gNB can initialize a channel occupancy after performing the Type 1 DL channel access procedure, and a UE can initialize a channel occupancy after performing the Type 1 UL channel access procedure. In the Type 1 DL/UL channel access procedure, the time duration spanned by the sensing slots that are sensed to be idle before a transmission is random, and the time duration include a first period (e.g., initial CCA period) consisting of a duration of 16 us and a fixed number (e.g., mₚ) of sensing slots, and a second period (e.g., extended CCA period) consisting of a random number (e.g., N) of sensing slots, wherein mₚ is determined based on the channel access priority class (CAPC) p, and a length of the sensing slot is 9 us, for 5 GHz and 6 GHz unlicensed spectrum.

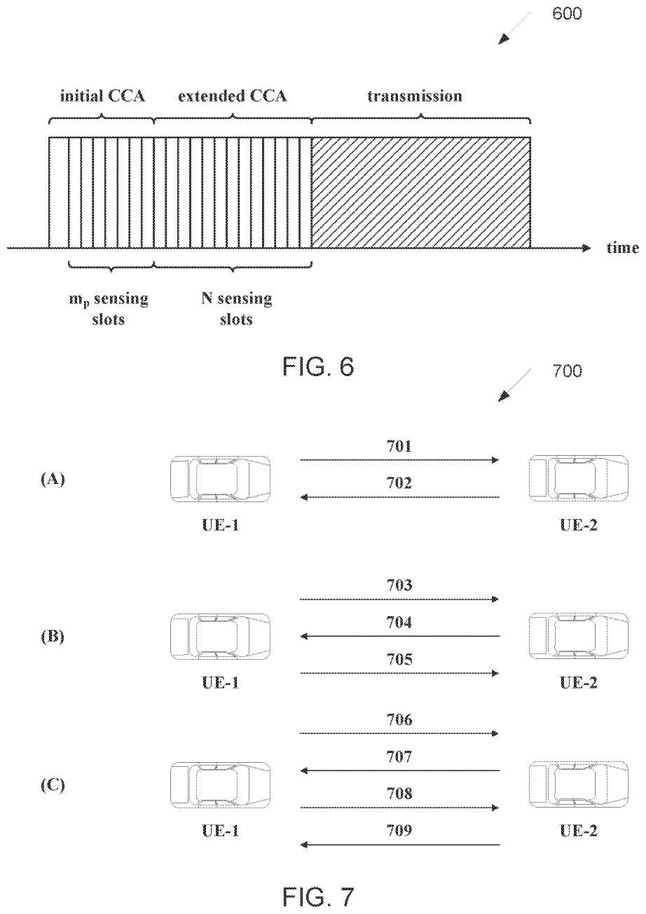

FIG. 6 illustrates an example of Type 1 DL/UL channel access procedure 600 according to various embodiments of the present disclosure. An embodiment of the Type 1 DL/UL channel access procedure 600 shown in FIG. 6 is for illustration only.

The random number N is an integer generated uniformly between 0 and CWₚ, and CWₚ is adjusted between a minimum value CW_{min,p} and a maximum value CW_{max,p}, according to the CAPC as well. After the Type 1 DL/UL channel access procedure, the node can occupy the channel for a maximum duration T_{mcot,p}, which is also based on the CAPC. In Rel-16 NR-U, 4 CAPCs are supported, and the mapping between CAPC (e.g., p) and its associated mₚ, CW_{min,p}, CW_{max,p}, T_{mcot,p}, and allowed values of CWₚ for DL and UL transmissions are shown in TABLE 1A and TABLE 1B, respectively.

TABLE 1A
Channel access priority class for DL

| CAPC | | | | T_{mcot, p} | |
|---|---|---|---|---|---|
| (p) | mₚ | CW_{min, p} | CW_{max, p} | (ms) | allowed CWₚ |
| 1 | 1 | 3 | 7 | 2 | {3, 7} |
| 2 | 1 | 7 | 15 | 3 | {7, 15} |
| 3 | 3 | 15 | 63 | 8 or 10 | {15, 31, 63} |
| 4 | 7 | 15 | 1023 | 8 or 10 | {15, 31, 63, 127, |
| | | | | | 255, 511, 1023} |

TABLE 1B
Channel access priority class for UL

| CAPC | | | | T_{mcot, p} | |
|---|---|---|---|---|---|
| (p) | mₚ | CW_{min, p} | CW_{max, p} | (ms) | allowed CWₚ |
| 1 | 1 | 3 | 7 | 2 | {3, 7} |
| 2 | 1 | 7 | 15 | 3 | {7, 15} |
| 3 | 3 | 15 | 1023 | 6 or 10 | {15, 31, 63, 127, |
| | | | | | 255, 511, 1023} |
| 4 | 7 | 15 | 1023 | 6 or 10 | {15, 31, 63, 127, |
| | | | | | 255, 511, 1023} |

A gNB can share its initialized channel occupancy (CO) with its serving UE(s), wherein the gNB indicates the type of channel access procedure for the UE(s) according to the gap between the DL and UL transmission.

For one example, the CO only includes one switching point between DL and UL transmissions, such that the CO starts with gNB's downlink transmission and proceeds with UE(s)' UL transmission, with a potential gap between the DL and UL transmission. For this example, the gNB can indicate the UE a type of channel access procedure based on the duration of the gap.

In one example of UL-LBT-1, if the gap is up to 16 us, the gNB can indicate the UE a Type 2C UL channel access procedure, wherein the time duration of sensing before the transmission is 0 (i.e., no sensing), and the maximum UL transmission duration subject to this type of channel access procedure is 584 us.

In one example of UL-LBT-2, if the gap is 16 us, the gNB can indicate the UE a Type 2B UL channel access procedure, wherein the time duration including the sensing slot(s) that are sensed to be idle before a transmission is 16 us.

In one example of UL-LBT-3, if the gap is larger or equals to 25 us, the gNB can indicate the UE a Type 2A UL channel access procedure, wherein the time duration including the sensing slot(s) that are sensed to be idle before a transmission is 25 us.

For another example, the CO can include multiple switching points between DL and UL transmissions, wherein the gap between any transmissions is no larger than 25 us. For this example, the gNB can perform a type of channel access procedure based on the duration of the gap between a UL transmission and a DL transmission.

In one example of DL-LBT-1, if the gap is up to 16 us, the gNB can perform a Type 2C DL channel access procedure, wherein the time duration of sensing before the transmission is 0 (i.e., no sensing), and the maximum DL transmission duration subject to this type of channel access procedure is 584 us.

In one example of DL-LBT-2, if the gap is 16 us, the gNB can perform a Type 2B DL channel access procedure, wherein the time duration including the sensing slot(s) that are sensed to be idle before a transmission is 16 us.

In one example of DL-LBT-3, if the gap is 25 us, the gNB can perform a Type 2A DL channel access procedure, wherein the time duration including the sensing slot(s) that are sensed to be idle before a transmission is 25 us.

Moreover, the gNB can indicate the UE a type of channel access procedure based on the duration of the gap, according to one of Example UL-LBT-1, Example UL-LBT-2, or Example UL-LBT-3.

A UE can also share its initialized CO with the gNB, wherein the gNB can determine the type of channel access procedure according to the gap between the UL and DL transmission. In Rel-16 NR-U, only single switching point between the UL transmission and DL transmission is allowed, and the gNB's DL transmission may contain transmission to the UE initializes the CO and can further include non-unicast and/or unicast transmissions where any unicast transmission is only transmitted to the UE initializes the CO. For this example, the gap between the UL and DL transmission cannot exceed 25 us, and the gNB can perform a type of channel access procedure based on the duration of the gap, according to one of Example DL-LBT-1, Example DL-LBT-2, or Example DL-LBT-3.

In Rel-16 NR SL, transmission and reception of signals and channels on sidelink are supported. The channels on sidelink include physical sidelink shared channel (PSSCH), physical sidelink control channel (PSCCH), and physical sidelink broadcast channel (PSBCH), and the signals on sidelink include sidelink primary synchronization signal (S-PSS), sidelink secondary synchronization signal (S-SSS), de-modulation reference signal (DM-RS), CSI-RS, and phase tracking reference signal (PT-RS).

For a sidelink operating with shared spectrum channel access, there is a need to support the channel occupancy sharing including the sidelink transmission. A UE can initialize a CO on sidelink or uplink channel and share the CO with other UE(s) or gNB. The present disclosure focuses on the conditions to support CO sharing, wherein the CO is initialized by a UE.

The present disclosure focuses on channel occupancy initialized by a UE and shared with other node(s) for downlink, sidelink, and/or uplink transmission(s). More precisely, this disclosure includes the following components: (1) CO sharing with sidelink transmission only, for example, (i) CO sharing between two UEs, (ii) CO sharing among multiple UEs with same initiating device, (iii) CO sharing among multiple UEs with different initiating devices, and (iv) CO sharing among multiple UEs with parallel transmissions; (2) CO sharing between sidelink and uplink; (3) CO sharing between sidelink and downlink; and (4) CO sharing between sidelink, uplink, and downlink.

For a sidelink operating with shared spectrum channel access, at least one of the following sidelink channel access procedures can be supported: (1) in Type 1 sidelink channel access procedure, the time duration spanned by the sensing slots that are sensed to be idle before a sidelink transmission is random, and this type of channel access procedure can be applicable to any transmission(s) initialized by a UE on sidelink; (2) in Type 2A sidelink channel access procedure, a UE may transmit a sidelink transmission immediately after sensing the channel to be idle for at least a sensing interval of 25 us; (3) in Type 2B sidelink channel access procedure, a UE may transmit a sidelink transmission immediately after sensing the channel to be idle for at least a sensing interval of 16 us; and (4) in Type 2C sidelink channel access procedure, a UE may transmit a sidelink transmission immediately without sensing the channel. In one further consideration, the duration of the sidelink transmission after performing the Type 2C sidelink channel access procedure is at most 584 us.

For a sidelink operating with shared spectrum channel access, at least one of the following examples can be utilized by a UE to start a transmission burst within a channel occupancy.

In one example of SL-LBT-1, if a UE can determine the duration of a time domain gap between its intended SL transmission and the previous transmission on the channel to be up to 16 us, the UE may perform the SL transmission(s) on the channel after performing Type 2C SL channel access procedure.

In one example of SL-LBT-2, if a UE can determine the duration of a time domain gap between its intended SL transmission and the previous transmission on the channel to be 16 us, the UE may perform the SL transmission(s) on the channel after performing Type 2B SL channel access procedure.

In one example of SL-LBT-3, if a UE can determine the duration of a time domain gap between its intended SL transmission and the previous transmission on the channel to be at least 25 us, the UE may perform the SL transmission(s) on the channel after performing Type 2A SL channel access procedure. In one variant of this example, if there is a further condition on the time domain gap to be at most 25 us, then the UE may perform the SL transmission(s) on the channel after performing Type 2A SL channel access procedure if the gap is 25 us.

In one example of SL-LBT-4, if a time domain gap between a UE's intended SL transmission and the previous transmission on the channel is up to 16 us, the UE can be indicated with a Type 2C SL channel access procedure and may perform the SL transmission(s) on the channel after performing the Type 2C SL channel access procedure.

In one example of SL-LBT-5, if a time domain gap between a UE's intended SL transmission and the previous transmission on the channel is 16 us, the UE can be indicated with a Type 2B SL channel access procedure and may perform the SL transmission(s) on the channel after performing the Type 2B SL channel access procedure.

In one example of SL-LBT-6, if a time domain gap between a UE's intended SL transmission and the previous transmission on the channel is at least 25 us, the UE can be indicated with a Type 2A SL channel access procedure and may perform the SL transmission(s) on the channel after performing the Type 2A SL channel access procedure. In one variant of this example, if there is a further condition on the time domain gap to be at most 25 us, then the UE can be indicated with a Type 2A SL channel access procedure and may perform the SL transmission(s) on the channel after performing the Type 2A SL channel access procedure if the gap is 25 us.

For a sidelink operating with shared spectrum channel access, at least one of the following examples can be applicable for a SL transmission burst.

In one example SL-Burst-1, the burst of SL transmission can include at least one of PSSCH, PSCCH, PSFCH (e.g., to a particular UE), S-SSB, and their associated RS, and the SL signal(s) and channel(s) in the SL transmission(s) can be multiplexed into a burst with the assumption that any time domain gap within the burst is not larger than a predefined threshold (e.g., 16 us). For one instance, the burst of SL transmission can be PSFCH (e.g. to a particular UE) only. For another instance, the burst of SL transmission can be PSCCH and/or PSSCH transmission.

In one example of SL-Burst-2, the PSSCH/PSCCH included in the SL transmission burst conveys broadcast information.

In one example of SL-Burst-3, the PSSCH/PSCCH included in the SL transmission burst conveys groupcast information, wherein the group of UE(s) for the reception of the PSSCH/PSCCH includes a particular UE.

In one example of SL-Burst-4, the PSSCH/PSCCH included in the SL transmission burst conveys unicast information, wherein the UE for the reception of the PSSCH/PSCCH is a particular UE.

In one example of SL-Burst-5, the PSSCH/PSCCH included in the SL transmission burst does not convey groupcast information, wherein the group of UE(s) for the reception of the PSSCH/PSCCH does not include a particular UE.

In one example of SL-Burst-6, the PSSCH/PSCCH included in the SL transmission burst does not convey unicast information, wherein the UE for the reception of the PSSCH/PSCCH is not a particular UE.

For a sidelink and/or uplink operating with shared spectrum channel access, a UE can perform a channel access procedure to perform transmission(s) including at least one of sidelink or uplink transmission (e.g., sidelink transmission and uplink transmission are IFDMed and mapped to different interlaces in the frequency domain, or sidelink transmission and uplink transmission are TDMed in a burst to make the time domain gap no larger than a predefined threshold, or sidelink transmission and uplink transmission are FDMed into a burst, or sidelink transmission and uplink transmission are CDMed into a burst), and at least one of the following UL/SL channel access procedures can be supported for a transmission burst including SL and/or UL transmission. In one instance, whether the UL/SL transmission is multiplexed from at least one of sidelink or uplink transmission using interlace based resource allocation can be a UE capability. In another instance, whether the UL/SL transmission is multiplexed from at least one of sidelink or uplink transmission using interlace based resource allocation can be indicated by the gNB (e.g. using a higher layer parameter, and/or a MAC CE, and/or a DCI format). In yet another instance, whether the UL/SL transmission is multiplexed from at least one of sidelink or uplink transmission using interlace based resource allocation can be indicated by the UE (e.g. using sidelink RRC parameter, and/or a SCI format). In yet another instance, whether the UL/SL transmission is multiplexed from at least one of sidelink or uplink transmission using interlace based resource allocation can be indicated by a pre-configuration (e.g. associated with the resource pool).

In one example of Type 1 UL/SL channel access procedure, the time duration spanned by the sensing slots that are sensed to be idle before a sidelink transmission is random, and this type of channel access procedure can be applicable to any UL/SL transmission(s) initialized by a UE.

In one example of Type 2A UL/SL channel access procedure, a UE may transmit a sidelink transmission immediately after sensing the channel to be idle for at least a sensing interval of 25 us.

In one example of Type 2B UL/SL channel access procedure, a UE may transmit a sidelink transmission immediately after sensing the channel to be idle for at least a sensing interval of 16 us.

In one example of Type 2A UL/SL channel access procedure, a UE may transmit a sidelink transmission immediately without sensing the channel. In one further consideration, the duration of the sidelink transmission after performing the Type 2A UL/SL channel access procedure is at most 584 us.

For a sidelink and/or uplink operating with shared spectrum channel access, at least one of the following examples can be utilized by a UE to start a UL/SL multiplexed transmission burst (e.g., IFDMed, FDMed, TDMed, or CDMed) within a channel occupancy.

In one example of UL-SL-LBT-1, if a UE can determine the duration of a time domain gap between its intended UL/SL transmission and the previous transmission on the channel to be up to 16 us, the UE may perform the UL/SL transmission(s) on the channel after performing Type 2C UL/SL channel access procedure.

In one example of UL-SL-LBT-2, if a UE can determine the duration of a time domain gap between its intended UL/SL transmission and the previous transmission on the channel to be 16 us, the UE may perform the UL/SL transmission(s) on the channel after performing Type 2B UL/SL channel access procedure.

In one example of UL-SL-LBT-3, if a UE can determine the duration of a time domain gap between its intended UL/SL transmission and the previous transmission on the channel to be at least 25 us, the UE may perform the UL/SL transmission(s) on the channel after performing Type 2A UL/SL channel access procedure. In one variant of this example, if there is a further condition on the time domain gap to be at most 25 us, then the UE may perform the UL/SL transmission(s) on the channel after performing Type UL/2A SL channel access procedure if the gap is 25 us.

In one example of UL-SL-LBT-4, if a time domain gap between a UE's intended UL/SL transmission and the previous transmission on the channel is up to 16 us, the UE can be indicated with a Type 2C UL/SL channel access procedure and may perform the SL transmission(s) on the channel after performing the Type 2C UL/SL channel access procedure.

In one example of UL-SL-LBT-5, if a time domain gap between a UE's intended UL/SL transmission and the previous transmission on the channel is 16 us, the UE can be indicated with a Type 2B UL/SL channel access procedure and may perform the UL/SL transmission(s) on the channel after performing the Type 2B UL/SL channel access procedure.

In one example of UL-SL-LBT-6, if a time domain gap between a UE's intended UL/SL transmission and the previous transmission on the channel is at least 25 us, the UE can be indicated with a Type 2A UL/SL channel access procedure and may perform the UL/SL transmission(s) on the channel after performing the Type 2A UL/SL channel access procedure. In one variant of this example, if there is a further condition on the time domain gap to be at most 25 us, then the UE can be indicated with a Type 2A UL/SL channel access procedure and may perform the UL/SL transmission(s) on the channel after performing the Type 2A UL/SL channel access procedure if the gap is 25 us.

For an uplink and/or sidelink operating with shared spectrum channel access, at least one of the following examples can be applicable for a UL/SL multiplexed transmission burst (e.g., IFDMed, FDMed, TDMed, or CDMed).

In one example of UL-SL-Burst-1, the burst of UL/SL transmission can be multiplexed into a burst with the assumption that any time domain gap within the burst is not larger than a predefined threshold (e.g., 16 us).

In one example of UL-SL-Burst-2, the PSSCH/PSCCH included in the SL transmission within the UL/SL burst conveys broadcast information.

In one example of UL-SL-Burst-3, the PSSCH/PSCCH included in the SL transmission within the UL/SL burst conveys groupcast information, wherein the group of UE(s) for the reception of the PSSCH/PSCCH includes a particular UE.

In one example of UL-SL-Burst-4, the PSSCH/PSCCH included in the SL transmission within the UL/SL burst conveys unicast information, wherein the UE for the reception of the PSSCH/PSCCH is a particular UE.

In one example of UL-SL-Burst-5, the PSSCH/PSCCH included in the SL transmission within the UL/SL burst does not convey groupcast information, wherein the group of UE(s) for the reception of the PSSCH/PSCCH does not include a particular UE.

In one example of UL-SL-Burst-6, the PSSCH/PSCCH included in the SL transmission within the UL/SL burst does not convey unicast information, wherein the UE for the reception of the PSSCH/PSCCH is not a particular UE.

In one embodiment, a first UE (e.g., UE-1) can initialize a channel occupancy for sidelink transmission(s) and share with a second UE (UE-2) for sidelink transmission(s).

In one example, the UE-1 performs a Type 1 SL channel access procedure to initialize the CO.

FIG. 7 illustrates an example of CO sharing between two UEs with SL transmissions only 700 according to various embodiments of the present disclosure. An embodiment of the CO sharing between two UEs with SL transmissions only 700 shown in FIG. 7 is for illustration only.

In one example, the UE-1 initializes the channel occupancy on sidelink and performs SL transmission(s) to UE-2 (e.g., 701), and UE-2 shares the channel occupancy initialized by UE-1 to perform SL transmission(s) (e.g., 702). This example is shown in FIG. 7 (e.g., (A)).

In another example, the UE-1 initializes the channel occupancy on sidelink and performs SL transmission(s) to UE-2 (e.g., 703), and UE-2 shares the channel occupancy initialized by UE-1 to perform SL transmission(s) (e.g., 704), and then UE-1 continues to perform SL transmission(s) in the CO after the transmission of UE-2 (e.g., 705). This example is shown in FIG. 7 (e.g., (B)).

In yet another example, the UE-1 initializes the channel occupancy on sidelink and performs SL transmission(s) to UE-2 (e.g., 706), and UE-2 shares the channel occupancy initialized by UE-1 to perform SL transmission(s) (e.g., 707), and UE-1 continues to perform SL transmission(s) in the CO after the transmission of UE-2 (e.g., 708), and then UE-2 further shares the CO to perform SL transmission(s) after the transmission of UE-1 (e.g., 709). This example is shown in FIG. 7 (e.g., (C)).

In one example, for this embodiment to be supported, at most one switch on the transmitter of the SL transmission(s) is allowed (e.g., only single switching point between the sidelink transmission bursts from the UE-1 perspective). For instance, the case as illustrated in (A) of FIG. 7 can be supported, and the cases as illustrated in (B) of FIG. 7 and (C) of FIG. 7 are not supported. For this example, UE-2 may transmit if there is no further SL transmission(s) from UE-1 after UE-2's transmission in the CO.

In one sub-example, there is a further condition on the duration of the gap when switching the transmitter. For one instance, the duration of the gap cannot exceed a pre-defined threshold (e.g., 25 us).

In another example, multiple switches on the transmitter of the SL transmission(s) are allowed (e.g., no limitation on the number of switching points between the sidelink transmission bursts). For instance, the case as illustrated in (A) of FIG. 7, (B) of FIG. 7 and/or (C) of FIG. 7 can be supported.

In one sub-example, there is a further condition on the duration of the gap(s) between the transmission bursts. For one instance, the duration of any gap between transmission bursts cannot exceed a pre-defined threshold (e.g., 25 us).

In one example, for this embodiment to be supported, there is a further condition on the SL transmission(s) from UE-1. For one instance, at least one of the examples on SL transmission burst described in this disclosure needs to be satisfied (e.g., Example SL-Burst-1 to SL-Burst-6), given the particular UE as UE-2 in the examples.

In another example, for this embodiment to be supported, there is a further condition on the SL transmission(s) from UE-2.

For one instance, the SL transmission(s) from UE-2 is a single transmission burst, and at least one of the examples on SL transmission burst described in this disclosure needs to be satisfied (e.g., Example SL-Burst-1 to SL-Burst-6), given the particular UE as UE-1 in the examples.

For another instance, the SL transmission(s) from UE-2 can be multiple transmission bursts (e.g., with interval between bursts larger than a pre-defined threshold, such as 16 us), and for each of the transmission burst, at least one of the examples on SL transmission burst described in this disclosure needs to be satisfied (e.g., Example SL-Burst-1 to SL-Burst-6), given the particular UE as UE-1 in the examples. For this instance, UE-2 may transmit one of the transmission bursts after performing channel access procedure given by at least one of the examples described in this disclosure (e.g., Example SL-LBT-1 to SL-LBT-6).

In yet another example, whether the CO initialized by the UE can be shared with other nodes can be provided to the UE, e.g. configured by a higher layer parameter (Uu link RRC and/or PC5 RRC), or provided by a pre-configuration.

In yet another example, for this embodiment to be supported, there can be a further condition on the priority of SL transmission(s) from UE-2. For one instance, if the priority of the SL transmission(s) from UE-2 is at least one of the same as or higher than the priority of the SL transmission(s) from UE-1, the CO initialized by the UE-1 can be shared to the UE-2.

In yet another example, whether the CO initialized by the UE can be shared with other nodes can be based on a further condition on the number or duration of failures in the channel access procedure. For one instance, if the number of failures in the channel access procedure exceeds a predefined threshold, the CO can be shared with other nodes after a successful channel access procedure. For another instance, if the duration of failures in the channel access procedure exceeds a predefined threshold, the CO can be shared with other nodes after a successful channel access procedure.

In yet another example, for the gap(s) when switching the transmitter, depending on the duration of the time domain gap, UE-2 may perform transmission on the SL after performing channel access procedure given by at least one of the examples described in this disclosure (e.g., Example SL-LBT-1 to SL-LBT-6).

In yet another example, if the SL energy detection threshold is not provided (e.g., configured by a higher layer parameter, and/or provided by a pre-configuration), at least one of the SL transmission(s) cannot include unicast transmission(s). For one instance, there is a further constraint on the duration of the SL transmission(s), e.g., no more than 2, 4, or 8 symbols for the SCS of SL BWP as 15, 30, or 60 kHz, respectively.

In one embodiment, a first UE (e.g., UE-1) can initialize a channel occupancy for sidelink transmission(s) and share with a set of other UEs for sidelink transmission(s).

In one example, the UE-1 performs a Type 1 SL channel access procedure to initialize the CO.

In one example, the UE-1 initializes the channel occupancy on sidelink and performs SL transmission(s) to a set of other UEs, and one or more other UEs in the set can share the channel occupancy initialized by UE-1 to perform SL transmission(s), wherein the SL transmission(s) from other UE(s) include UE-1 as receiver or one of the receivers.

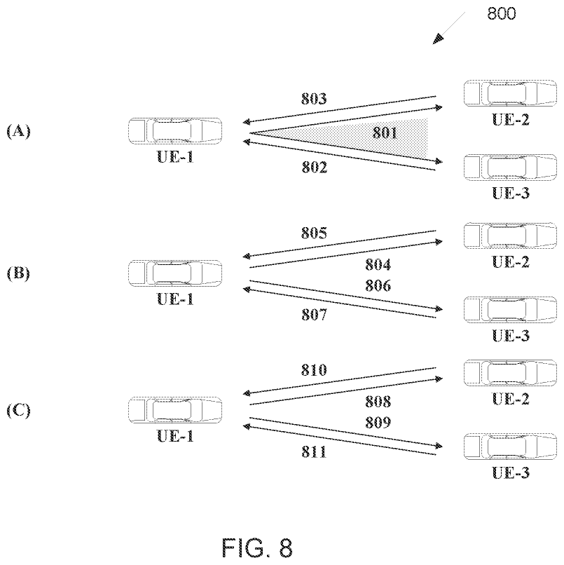

FIG. 8 illustrates an example of CO sharing among multiple UEs with the same initiating device 800 according to various embodiments of the present disclosure. An embodiment of the CO sharing among multiple UEs with the same initiating device 800 shown in FIG. 8 is for illustration only.

In one instance, the SL transmission(s) from UE-1 can be broadcast or groupcast (e.g., 801), with the set of other UEs as receivers of the transmission. This example is shown in FIG. 8 (e.g., (A)) (although only UE-2 (e.g., 803) and UE-3 (e.g., 802) are shown as illustration of the set of other UEs, the example can be applicable to more than two other UEs).

In another instance, the SL transmission(s) from UE-1 (e.g., 808 and 809) can be a set of contiguous transmissions (e.g., at least including unicast transmission), with the set of other UEs as receivers of the contiguous transmissions. This example is shown in FIG. 8 (e.g., (C)) (although only UE-2 (e.g., 810) and UE-3 (e.g., 811) are shown as illustration of the set of other UEs, the example can be applicable to more than two other UEs).

In yet another instance, the SL transmission(s) from UE-1 (e.g., 804 and 806) can be a set of non-contiguous transmissions (e.g., at least including unicast transmission), wherein each transmission may be with one or more of UEs in the set of other UEs as receiver(s). This example is shown in FIG. 8 (e.g., (B)) (although only UE-2 (e.g., 805) and UE-3 (e.g., 807) are shown as illustration of the set of other UEs, the example can be applicable to more than two other UEs).

In yet another instance, the SL transmission(s) from UE-1 can be a combination of at least two of above instances, such as combination of examples by using a TMD manner, or combination of examples by supporting more than two other UEs wherein each two other UEs use one of the examples.

In one example, for this embodiment to be supported, the UE initializing the CO (e.g., UE-1) cannot continue to transmit if other UE shares the CO and transmits (e.g., at most one switching point from UE-1 perspective). For instance, the cases as illustrated in (A) of FIG. 8 and/or (C) of FIG. 8 can be supported, and the cases as illustrated in (B) of FIG. 8 is not supported. For this example, UE-2 or UE-3 may transmit if there is no further SL transmission(s) from UE-1 after their transmission in the CO.

In one sub-example, there is a further condition on the duration of the time domain gap between UE-1's transmission(s) and the proceeding transmission. For one instance, the duration of the gap cannot exceed a pre-defined threshold (e.g., 25 us).

In another example, the UE initializing the CO (e.g., UE-1) can continue to transmit after other UE shares the CO and transmits (e.g., no limitation on the number of switching points from UE-1 perspective). For instance, the cases as illustrated in (A) of FIG. 8, (B) of FIG. 8, and/or (C) of FIG. 8 can be supported.

In one sub-example, there is a further condition on the duration of the time domain gap(s) between the transmission bursts. For one instance, the duration of any gap between transmission bursts cannot exceed a pre-defined threshold (e.g., 25 us).

In one example, for this embodiment to be supported, there is a further condition on the SL transmission(s) from UE-1. For one instance, at least one of the examples on SL transmission burst described in this disclosure needs to be satisfied (e.g., Example SL-Burst-1 to SL-Burst-6), given the particular UE as one of the UE from the set of other UEs in the examples.

In another example, for this embodiment to be supported, there is a further condition on the SL transmission(s) from the set of other UEs (e.g., UE-2 and/or UE-3).

For one instance, the SL transmission(s) from any UE in the set of other UEs is a single transmission burst, and at least one of the examples on SL transmission burst described in this disclosure needs to be satisfied (e.g., Example SL-Burst-1 to SL-Burst-6), given the particular UE as UE-1 in the examples.

For another instance, the SL transmission(s) from any UE in the set of other UEs can be multiple transmission bursts (e.g., with interval between bursts larger than a pre-defined threshold, such as 16 us), and for each of the transmission burst, at least one of the examples on SL transmission burst described in this disclosure needs to be satisfied (e.g., Example SL-Burst-1 to SL-Burst-6), given the particular UE as UE-1 in the examples. For this instance, any UE in the set of other UEs may transmit one of the transmission bursts after performing channel access procedure given by at least one of the examples described in this disclosure (e.g., Example SL-LBT-1 to SL-LBT-6).

In yet another example, whether the CO initialized by the UE can be shared with other nodes can be provided to the UE, e.g. configured by a higher layer parameter (Uu link RRC and/or PC5 RRC), or provided by a pre-configuration.

In yet another example, for this embodiment to be supported, there can be a further condition on the priority of SL transmission(s) from other UE(s). For one instance, if the priority of the SL transmission(s) from other UE(s) (e.g., UE-2 or UE-3) is at least one of the same as or higher than the priority of the SL transmission(s) from UE-1, the CO initialized by the UE-1 can be shared to the corresponding UE.

In yet another example, whether the CO initialized by the UE can be shared with other nodes can be based on a further condition on the number or duration of failures in the channel access procedure. For one instance, if the number of failures in the channel access procedure exceeds a predefined threshold, the CO can be shared with other nodes after a successful channel access procedure. For another instance, if the duration of failures in the channel access procedure exceeds a predefined threshold, the CO can be shared with other nodes after a successful channel access procedure.

In yet another example, for the gap(s) when switching the transmitter, depending on the duration of the gap, any UE in the set of other UEs may perform transmission on the SL after performing channel access procedure given by at least one of the examples described in this disclosure (e.g., Example SL-LBT-1 to SL-LBT-6).

In yet another example, if the SL energy detection threshold is not provided (e.g., configured by a higher layer parameter, and/or provided by a pre-configuration), at least one of the SL transmission(s) cannot include unicast transmission(s). For one instance, there is a further constraint on the duration of the SL transmission(s), e.g., no more than 2, 4, or 8 symbols for the SCS of SL BWP as 15, 30, or 60 kHz, respectively.

In one embodiment, a first UE (e.g., UE-1) can initialize a channel occupancy for sidelink transmission(s) and share with a set of other UEs for sidelink transmission(s).

In one example, the UE-1 performs a Type 1 SL channel access procedure to initialize the CO.

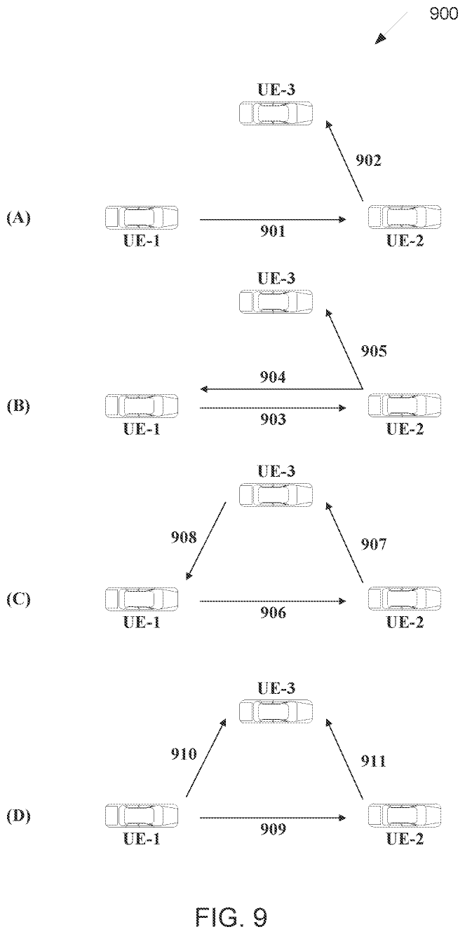

FIG. 9 illustrates an example of CO sharing among multiple UEs with the different initiating devices 900 according to various embodiments of the present disclosure. An embodiment of the CO sharing among multiple UEs with the different initiating devices 900 shown in FIG. 9 is for illustration only.

In one example, the UE-1 initializes the channel occupancy on sidelink and performs SL transmission(s) to a first set of other UEs (e.g., 901), and one or more other UEs in the first set can share the channel occupancy initialized by UE-1 to perform SL transmission(s), wherein the SL transmission(s) from other UE(s) in the first set (e.g., UE-2) include a second set of other UE(s) (e.g., UE-3) as the receiver(s) (e.g., 902). This example is shown in FIG. 9 (e.g., (A)), wherein only single UE-2 in the first set of other UE(s) and single UE-3 in the second set of other UE(s) are only for illustration purpose, and the example can be applicable to more than one UEs in the first and/or the second set of other UE(s). In one further consideration, the example can be supported, if there is a further condition on the SL transmission from the first set of other UEs (e.g., UE-2) to the second set of other UEs (e.g., UE-3).

In one instance, the SL transmission (e.g., 905) from the first set of other UEs (e.g., UE-2) to the second set of other UEs (e.g., UE-3) may include the UE initializing the CO (e.g., UE-1) (e.g., 904) as one of its additional receiver (e.g., by broadcast and/or groupcast), and/or the SL transmission from the first set of other UEs (e.g., UE-2) to the second set of other UEs (e.g., UE-3) may be multiplexed with SL transmission(s) from the first set of other UEs (e.g., UE-2) to the UE initializing the CO (e.g., UE-1) (e.g., by forming a burst). This instance is shown in FIG. 9 (e.g., (B)).

In another instance, the SL transmission from the first set of other UEs (e.g., UE-2) to the second set of other UEs (e.g., UE-3) (e.g., 907) may be followed with a further SL transmission from the second set of other UEs (e.g., UE-3) to the UE initializing the CO (e.g., UE-1) (e.g., 908). This instance is shown in FIG. 9 (e.g., (C)).

In yet another instance, the second set of other UEs (e.g., UE-3) may be as receiver(s) (e.g., 910 and 911) in at least one of the previous SL transmission(s) within the CO, wherein the SL transmission(s) is from the UE initializing the CO (e.g., UE-1). This instance is shown in FIG. 9 (e.g., (D)).

In yet another instance, combination of at least two of above instances can be supported.

In one example, for this embodiment to be supported, the UE initializing the CO (e.g., UE-1) cannot continue to transmit if other UE shares the CO and transmits (e.g., at most one switching point from UE-1 perspective). For instance, only the first set of other UEs (e.g., UE-2) can share the CO and perform transmission(s) as the transmitter(s).

In one sub-example, there is a further condition on the duration of the time domain gap between UE-1's transmission(s) and the proceeding transmission. For one instance, the duration of the gap cannot exceed a pre-defined threshold (e.g., 25 us).

In another example, the UE initializing the CO (e.g., UE-1) can continue to transmit after other UE shares the CO and transmits (e.g., no limitation on the number of switching points from UE-1 perspective). For instance, the CO can be shared to a first set of other UE(s) (e.g., UE-2) as transmitter(s) of SL transmission(s), and further shared to a second set of other UE(s) (e.g., UE-3) as transmitter(s) of SL transmission(s), and so on, until the maximum channel occupancy time is achieved.

In one sub-example, there is a further condition on the duration of the gap(s) between the transmission bursts. For one instance, the duration of any gap between transmission bursts cannot exceed a pre-defined threshold (e.g., 25 us).

In another sub-example, there is no condition on the duration of the gap(s) between the transmission bursts. For one instance, the duration of gap(s) is not counted into the channel occupancy time.

In one example, for this embodiment to be supported, there is a further condition on the SL transmission(s) from UE-1. For one instance, at least one of the examples on SL transmission burst described in this disclosure needs to be satisfied (e.g., Example SL-Burst-1 to SL-Burst-6), given the particular UE as one of the UE from the first set of other UEs (e.g., UE-2) in the examples.

In another example, for this embodiment to be supported, there is a further condition on the SL transmission(s) from the first set of other UEs (e.g., UE-2) to the second set of other UEs (e.g., UE-3).

For one instance, the SL transmission(s) from the first set of other UEs (e.g., UE-2) to the second set of other UEs (e.g., UE-3) is a single transmission burst, and at least one of the examples on SL transmission burst described in this disclosure needs to be satisfied (e.g., Example SL-Burst-1 to SL-Burst-6), given the particular UE as a UE in the second set of other UEs (e.g., UE-3) in the examples.

For another instance, the SL transmission(s) from the first set of other UEs (e.g., UE-2) to the second set of other UEs (e.g., UE-3) can be multiple transmission bursts (e.g., with interval between bursts larger than a pre-defined threshold, such as 16 us), and for each of the transmission burst, at least one of the examples on SL transmission burst described in this disclosure needs to be satisfied (e.g., Example SL-Burst-1 to SL-Burst-6), given the particular UE as a UE in the second set of other UEs (e.g., UE-3) in the examples. For this instance, the UE in the first set of other UEs (e.g., UE-2) may transmit one of the transmission bursts after performing channel access procedure given by at least one of the examples described in this disclosure (e.g., Example SL-LBT-1 to SL-LBT-6).

In yet another example, whether the CO initialized by the UE can be shared with other nodes can be provided to the UE, e.g., configured by a higher layer parameter (Uu link RRC and/or PC5 RRC), or provided by a pre-configuration.

In yet another example, for this embodiment to be supported, there can be a further condition on the priority of SL transmission(s). For one instance, if the priority of the next intended SL transmission(s) is at least one of the same as or higher than the priority of the current SL transmission(s), the CO can be shared to the perform the next intended SL transmission.

In yet another example, whether the CO initialized by the UE can be shared with other nodes can be based on a further condition on the number or duration of failures in the channel access procedure. For one instance, if the number of failures in the channel access procedure exceeds a predefined threshold, the CO can be shared with other nodes after a successful channel access procedure. For another instance, if the duration of failures in the channel access procedure exceeds a predefined threshold, the CO can be shared with other nodes after a successful channel access procedure.

In yet another example, for the gap(s) when switching the transmitter, depending on the duration of the gap, a UE in the first set of other UEs (e.g., UE-2) may perform transmission on the SL after performing channel access procedure given by at least one of the examples described in this disclosure (e.g., Example SL-LBT-1 to SL-LBT-6).

In yet another example, if the SL energy detection threshold is not provided (e.g., configured by a higher layer parameter, and/or provided by a pre-configuration), at least one of the SL transmission(s) cannot include unicast transmission(s). For one instance, there is a further constraint on the duration of the SL transmission(s), e.g., no more than 2, 4, or 8 symbols for the SCS of SL BWP as 15, 30, or 60 kHz, respectively.

In one embodiment, a first UE (e.g., UE-1) can initialize a channel occupancy for sidelink transmission(s) and share the CO with a second UE (e.g., UE-3) to perform sidelink transmission(s).

In one example, the UE-1 performs a Type 1 SL channel access procedure to initialize the CO.

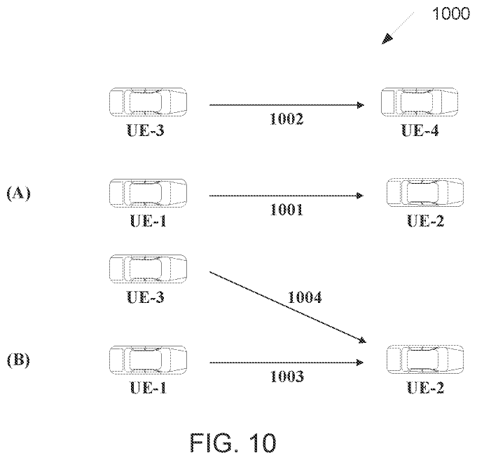

FIG. 10 illustrates an example of CO sharing between parallel sidelink transmissions 1000 according to various embodiments of the present disclosure. An embodiment of the CO sharing between parallel sidelink transmissions 1000 shown in FIG. 10 is for illustration only.

In one example, the first UE (e.g., UE-1) initializes the channel occupancy on sidelink and performs SL transmission(s) to a first set of other UEs (e.g., UE-2) (e.g., 1001), and the second UE (e.g., UE-3) shares the channel occupancy and performs SL transmission(s) to a second set of other UEs (e.g., UE-4) (e.g., 1002). This example is shown in FIG. 10 (e.g., (A)).

In one sub-example, the first set of other UEs and the second set of other UEs are required to be the same, e.g., common receiver(s) for the first UE and the second UE's SL transmission(s). For instance, the example is shown in FIG. 10 (e.g., (B)).

In another sub-example, there is a further condition on the second UE for the example to be supported. For instance, the second UE is a receiver or as one receiver in the receiver list for a previous transmission from the first UE in the same channel occupancy.

In yet another sub-example, there is a further condition on the set of UEs for the example to be supported. For instance, at least one of the first UE, the second UE, the first set of other UEs, or the second set of other UEs are within the coverage of a gNB.

In one example, for this embodiment to be supported, the UE initializing the CO (e.g., UE-1) cannot continue to transmit if other UE shares the CO and transmits (e.g., at most one switching point from UE-1 perspective). For instance, only the second UE (e.g., UE-3) can share the CO and perform transmission(s) as the transmitter(s).

In one sub-example, there is a further condition on the duration of the gap between UE-1's transmission(s) and the proceeding transmission. For one instance, the duration of the gap cannot exceed a pre-defined threshold (e.g., 25 us).

In another example, the UE initializing the CO (e.g., UE-1) can continue to transmit after other UE shares the CO and transmits (e.g., no limitation on the number of switching points from UE-1 perspective). For instance, the CO can be shared to a second UE (e.g., UE-3) as transmitter(s) of SL transmission(s), and further shared to a third UE as transmitter(s) of SL transmission(s), and so on, until the maximum channel occupancy time is achieved.

In one sub-example, there is a further condition on the duration of the gap(s) between the transmission bursts. For one instance, the duration of any gap between transmission bursts cannot exceed a pre-defined threshold (e.g., 25 us).

In another sub-example, there is no condition on the duration of the gap(s) between the transmission bursts. For one instance, the duration of gap(s) is not counted into the channel occupancy time.

In one example, for this embodiment to be supported, there is a further condition on the SL transmission(s) from the first UE (e.g., UE-1) to the first set of other UEs (e.g., UE-2). For one instance, at least one of the examples on SL transmission burst described in this disclosure needs to be satisfied (e.g., Example SL-Burst-1 to SL-Burst-6), given the particular UE as one of the UE from the first set of other UEs (e.g., UE-2) in the examples.

In another example, for this embodiment to be supported, there is a further condition on the SL transmission(s) from the second UE (e.g., UE-3) to the second set of other UEs (e.g., UE-4).

For one instance, the SL transmission(s) from the second UE (e.g., UE-3) to the second set of other UEs (e.g., UE-4) is a single transmission burst, and at least one of the examples on SL transmission burst described in this disclosure needs to be satisfied (e.g., Example SL-Burst-1 to SL-Burst-6), given the particular UE as a UE in the second set of other UEs (e.g., UE-4) in the examples.

For another instance, the SL transmission(s) from the second UE (e.g., UE-3) to the second set of other UEs (e.g., UE-4) can be multiple transmission bursts (e.g., with interval between bursts larger than a pre-defined threshold, such as 16 us), and for each of the transmission burst, at least one of the examples on SL transmission burst described in this disclosure needs to be satisfied (e.g., Example SL-Burst-1 to SL-Burst-6), given the particular UE as a UE in the second set of other UEs (e.g., UE-4) in the examples. For this instance, the second UE (e.g., UE-3) may transmit one of the transmission bursts after performing channel access procedure given by at least one of the examples described in this disclosure (e.g., Example SL-LBT-1 to SL-LBT-6).

In yet another example, whether the CO initialized by the UE can be shared with other nodes can be provided to the UE, e.g., configured by a higher layer parameter (Uu link RRC and/or PC5 RRC), or provided by a pre-configuration.

In yet another example, for this embodiment to be supported, there can be a further condition on the priority of SL transmission(s). For one instance, if the priority of the next intended SL transmission(s) is at least one of the same as or higher than the priority of the current SL transmission(s), the CO can be shared to the perform the next intended SL transmission.

In yet another example, whether the CO initialized by the UE can be shared with other nodes can be based on a further condition on the number or duration of failures in the channel access procedure. For one instance, if the number of failures in the channel access procedure exceeds a predefined threshold, the CO can be shared with other nodes after a successful channel access procedure. For another instance, if the duration of failures in the channel access procedure exceeds a predefined threshold, the CO can be shared with other nodes after a successful channel access procedure.

In yet another example, for the gap(s) when switching the transmitter, depending on the duration of the gap, the second UE (e.g., UE-3) may perform transmission on the SL after performing channel access procedure given by at least one of the examples described in this disclosure (e.g., Example SL-LBT-1 to SL-LBT-6).

In yet another example, if the SL energy detection threshold is not provided (e.g., configured by a higher layer parameter, and/or provided by a pre-configuration), at least one of the SL transmission(s) cannot include unicast transmission(s). For one instance, there is a further constraint on the duration of the SL transmission(s), e.g., no more than 2, 4, or 8 symbols for the SCS of SL BWP as 15, 30, or 60 kHz, respectively.

In one embodiment, a UE (e.g., UE-1) can initialize a channel occupancy for sidelink transmission(s) and share the CO for sidelink and/or uplink transmission(s), and/or initialize a channel occupancy for uplink transmission(s) and share the CO for sidelink and/or uplink transmission(s).

In one example, when initializing the channel occupancy for sidelink transmission(s), the UE-1 performs a Type 1 SL channel access procedure to initialize the CO.

In another example, when initializing the channel occupancy for uplink transmission(s), the UE-1 performs a Type 1 UL channel access procedure to initialize the CO.

In yet another example, when initializing the channel occupancy for multiplexed sidelink and uplink transmission(s), the UE-1 performs a Type 1 UL/SL channel access procedure to initialize the CO.

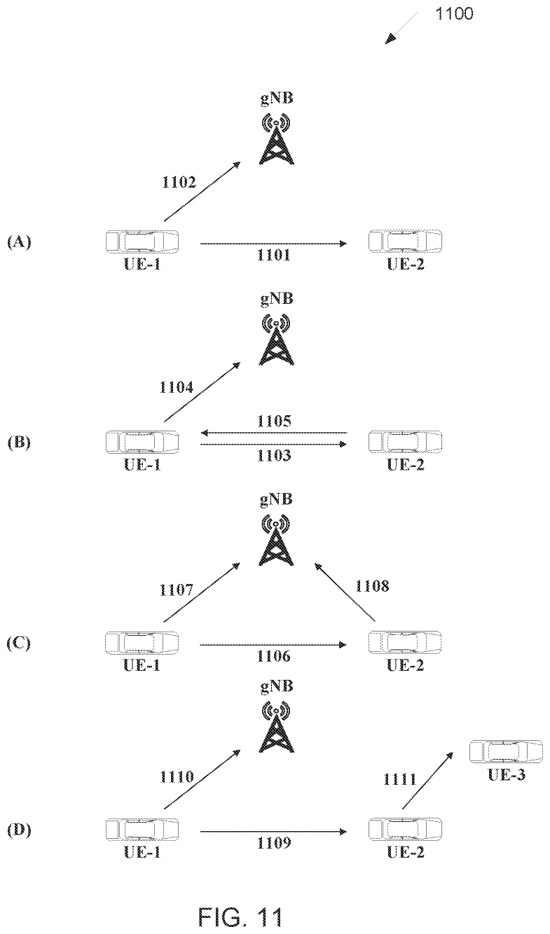

FIG. 11 illustrates an example of CO sharing between SL and UL 1100 according to various embodiments of the present disclosure. An embodiment of the CO sharing between SL and UL 1100 shown in FIG. 11 is for illustration only.

In one example, the UE-1 initializes the channel occupancy on sidelink and performs SL transmission(s) to a set of other UE(s) (e.g., UE-2) (e.g., 1101), and the UE-1 can share the CO and multiplex at least one UL transmission(s) to a gNB with the SL transmission(s) (e.g., 1102). The example is shown in FIG. 11 (e.g., (A)).

In another example, the UE-1 initializes the channel occupancy on uplink and performs UL transmission(s) to a gNB, and the UE-1 can share the CO and multiplex at least one SL transmission(s) with the UL transmission(s). The example is shown in FIG. 11 (e.g., (A)).

In yet another example, the UE-1 initializes the channel occupancy and perform multiplexed UL/SL transmissions to a gNB and a set of other UE(s) (e.g., UE-2), respectively. The example is shown in FIG. 11 (e.g., (A)).

In one example, after the transmission from the UE-1 to a UE-2 (e.g., 1103), the UE-2 can further share the CO and perform SL transmission(s) to UE-1 (e.g., 1103). The example is shown in FIG. 11 (e.g., (B)). For one instance, the UL transmission(s) 1104 can be TDMed with the SL transmission(s) 1105. In another instance, the UL transmission(s) 1104 can be IFDMed, FDMed, or CDMed with the SL transmission(s) 1105.

In another example, after the transmission from the UE-1 to UE-2, UE-2 can further share the CO and perform UL transmission(s) to the gNB. The example is shown in FIG. 11 (e.g., (C)). For one instance, the UL transmission(s) 1107 can be TDMed with the UL transmission(s) 1108. In another instance, the UL transmission(s) 1107 can be IFDMed, FDMed, or CDMed with the UL transmission(s) 1108.

In yet another example, after the transmission from the UE-1 to a UE-2, the UE-2 can further share the CO and perform UL transmission(s) to a third UE (e.g., UE-3). The example is shown in FIG. 11 (e.g., (D)). For one instance, the UL transmission(s) 1110 can be TDMed with the SL transmission(s) 1111. In another instance, the UL transmission(s) 1110 can be IFDMed, FDMed, or CDMed with the SL transmission(s) 1111.

In one example, for this embodiment to be supported, the UE initializing the CO (e.g., UE-1) cannot continue to transmit if other UE shares the CO and transmits (e.g., at most one switching point from UE-1 perspective). For instance, only the set of other UEs (e.g., UE-2) can share the CO and perform transmission(s) as the transmitter(s).

In one sub-example, there is a further condition on the duration of the gap between UE-1's transmission(s) and the proceeding transmission. For one instance, the duration of the gap cannot exceed a pre-defined threshold (e.g., 25 us).

In another example, the UE initializing the CO (e.g., UE-1) can continue to transmit after other UE shares the CO and transmits (e.g., no limitation on the number of switching points from UE-1 perspective).

In one sub-example, there is a further condition on the duration of the gap(s) between the transmission bursts. For one instance, the duration of any gap between transmission bursts cannot exceed a pre-defined threshold (e.g., 25 us).

In another sub-example, there is no condition on the duration of the gap(s) between the transmission bursts. For one instance, the duration of gap(s) is not counted into the channel occupancy time.

In one example, for this embodiment to be supported, there is a further condition on the UE(s). For instance, at least one of the first set of UE(s) (e.g., UE-1) or the second set of UE(s) (e.g., UE-2) or the third set of UE(s) (e.g., UE-3) is within the coverage of the gNB.

In one example, for this embodiment to be supported, there is a further condition on the UL/SL transmission(s) from UE-1. For one instance, at least one of the examples on UL/SL transmission burst described in this disclosure needs to be satisfied (e.g., Example UL-SL-Burst-1 to UL-SL-Burst-6), given the particular UE as one of the UE from the set of other UEs (e.g., UE-2) in the examples.

In another example, for this embodiment to be supported, there is a further condition on the SL transmission(s) from UE-1. For one instance, at least one of the examples on SL transmission burst described in this disclosure needs to be satisfied (e.g., Example SL-Burst-1 to SL-Burst-6), given the particular UE as one of the UE from the set of other UEs (e.g., UE-2) in the examples.

In yet another example, whether the CO initialized by the UE can be shared with other nodes can be provided to the UE, e.g., configured by a higher layer parameter (Uu link RRC and/or PC5 RRC), or provided by a pre-configuration. In one instance, the information on whether a CO can be shared for UL transmission and SL transmission can be provided to the UE separately (e.g., separate indication). In another instance, the information on whether a CO can be shared for UL transmission and SL transmission can be provided to the UE jointly (e.g., joint indication).

In yet another example, for this embodiment to be supported, there can be a further condition on the priority of SL transmission(s). For one instance, if the priority of the next intended SL transmission(s) is at least one of the same as or higher than the priority of the current SL transmission(s), the CO can be shared to the perform the next intended SL transmission.

In yet another example, whether the CO initialized by the UE can be shared with other nodes can be based on a further condition on the number or duration of failures in the channel access procedure. For one instance, if the number of failures in the channel access procedure exceeds a predefined threshold, the CO can be shared with other nodes after a successful channel access procedure. For another instance, if the duration of failures in the channel access procedure exceeds a predefined threshold, the CO can be shared with other nodes after a successful channel access procedure.

In yet another example, for the gap(s) when switching between transmission bursts in the CO, depending on the duration of the gap, the first UE (e.g., UE-1) may perform transmission on the SL after performing channel access procedure given by at least one of the examples described in this disclosure (e.g., Example SL-LBT-1 to SL-LBT-6), or perform transmission on the UL after performing channel access procedure given by at least one of the examples described in this disclosure (e.g., Example UL-LBT-1 to UL-LBT-3).

In yet another example, for the gap(s) when switching between a UL/SL transmission and the previous transmission in the CO, depending on the duration of the gap, a sidelink UE may perform the UL/SL transmission after performing channel access procedure given by at least one of the examples described in this disclosure (e.g., Example UL-SL-LBT-1 to UL-SL-LBT-6).

In yet another example, if the SL energy detection threshold is not provided (e.g., configured by a higher layer parameter, and/or provided by a pre-configuration), at least one of the SL transmission(s) cannot include unicast transmission(s). For one instance, there is a further constraint on the duration of the SL transmission(s), e.g., no more than 2, 4, or 8 symbols for the SCS of SL BWP as 15, 30, or 60 kHz, respectively.

In one embodiment, a UE (e.g., UE-1) can initialize a channel occupancy for sidelink transmission(s) and share the CO to a gNB for downlink transmission(s).

In one example, when initializing the channel occupancy for sidelink transmission(s), the UE-1 performs a Type 1 SL channel access procedure to initialize the CO.

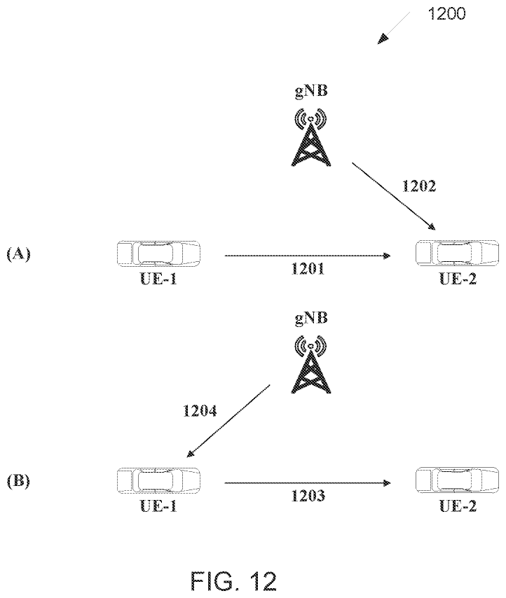

FIG. 12 illustrates an example of CO sharing between SL and DL 1200 according to various embodiments of the present disclosure. An embodiment of the CO sharing between SL and DL 1200 shown in FIG. 12 is for illustration only.

In one example, the UE-1 initializes the channel occupancy on sidelink and performs SL transmission(s) to a set of other UE(s) (e.g., UE-2) (e.g., 1201), and the UE-1 can share the CO to a gNB such that the gNB can perform DL transmission(s) to the UE-2 (e.g., 1202). This example is shown in FIG. 12 (e.g., (A)).

In another example, the UE-1 initializes the channel occupancy on sidelink and performs SL transmission(s) to a set of other UE(s) (e.g., UE-2) (e.g., 1203), and the UE-1 can share the CO to a gNB such that the gNB can perform DL transmission(s) to the UE-1 (e.g., 1204). This example is shown in FIG. 12 (e.g., (B)).

In one example, for this embodiment to be supported, the UE initializing the CO (e.g., UE-1) cannot continue to transmit if a gNB shares the CO and transmits (e.g., at most one switching point from UE-1 perspective).

In one sub-example, there is a further condition on the duration of the gap between UE-1's transmission(s) and the proceeding transmission. For one instance, the duration of the gap cannot exceed a pre-defined threshold (e.g., 25 us).

In another example, the UE initializing the CO (e.g., UE-1) can continue to transmit after the gNB shares the CO and transmits (e.g., no limitation on the number of switching points from UE-1 perspective).

In one sub-example, there is a further condition on the duration of the gap(s) between the transmission bursts. For one instance, the duration of any gap between transmission bursts cannot exceed a pre-defined threshold (e.g., 25 us).

In another sub-example, there is no condition on the duration of the gap(s) between the transmission bursts. For one instance, the duration of gap(s) is not counted into the channel occupancy time.

In one example, there is a further condition on the set of UEs for the example to be supported. For instance, at least one of the UE initializing the CO (e.g., UE-1) or the UE(s) receiving the SL transmission(s) (e.g., UE-2) is within the coverage of the gNB.

In one example, for this embodiment to be supported, there is a further condition on the SL transmission(s) from the first UE (e.g., UE-1) to the set of other UEs (e.g., UE-2). For one instance, at least one of the examples on SL transmission burst described in this disclosure needs to be satisfied (e.g., Example SL-Burst-1 to SL-Burst-6), given the particular UE as one of the UE from the set of other UEs (e.g., UE-2) in the examples.

In another example, for this embodiment to be supported, there is a further condition on the DL transmission(s) from the gNB. For one instance, the DL transmission(s) convey non-unicast information. For another instance, the DL transmission(s) convey unicast information with a particular UE as the receiver (e.g., the particular UE is UE-2 in (A) of FIG. 12 or UE-1 in (B) of FIG. 12). For yet another instance, the DL transmission(s) cannot convey unicast information to other UEs except for a particular UE (e.g., the particular UE is UE-2 in (A) of FIG. 12 or UE-1 in (B) of FIG. 12).

In yet another example, for the gap(s) when switching the transmitter, depending on the duration of the gap, the gNB may perform transmission on the DL after performing channel access procedure given by at least one of the examples described in this disclosure (e.g., Example DL-LBT-1 to DL-LBT-3).

In yet another example, if the SL energy detection threshold is not provided (e.g., configured by a higher layer parameter, and/or provided by a pre-configuration), at least one of the SL transmission(s) cannot include unicast transmission(s). For one instance, there is a further constraint on the duration of the SL transmission(s), e.g., no more than 2, 4, or 8 symbols for the SCS of SL BWP as 15, 30, or 60 kHz, respectively.

In yet another example, if the DL energy detection threshold is not provided (e.g., configured by a higher layer parameter, and/or provided by a pre-configuration), the DL transmission(s) cannot include unicast transmission(s). For one instance, there is a further constraint on the duration of the DL transmission(s), e.g., no more than 2, 4, or 8 symbols for the SCS of SL BWP as 15, 30, or 60 kHz, respectively.

In one embodiment, a UE (e.g., UE-1) can initialize a channel occupancy for sidelink transmission(s) and/or uplink transmission(s) and share the CO to a set of other UE(s) (e.g., UE-2) for sidelink and/or uplink transmission(s) and/or to a gNB for downlink transmission(s).

In one example, when initializing the channel occupancy for sidelink transmission(s), the UE-1 performs a Type 1 SL channel access procedure to initialize the CO.

In another example, when initializing the channel occupancy for uplink transmission(s), the UE-1 performs a Type 1 UL channel access procedure to initialize the CO.

In yet another example, when initializing the channel occupancy for multiplexed sidelink and uplink transmission(s), the UE-1 performs a Type 1 UL/SL channel access procedure to initialize the CO.

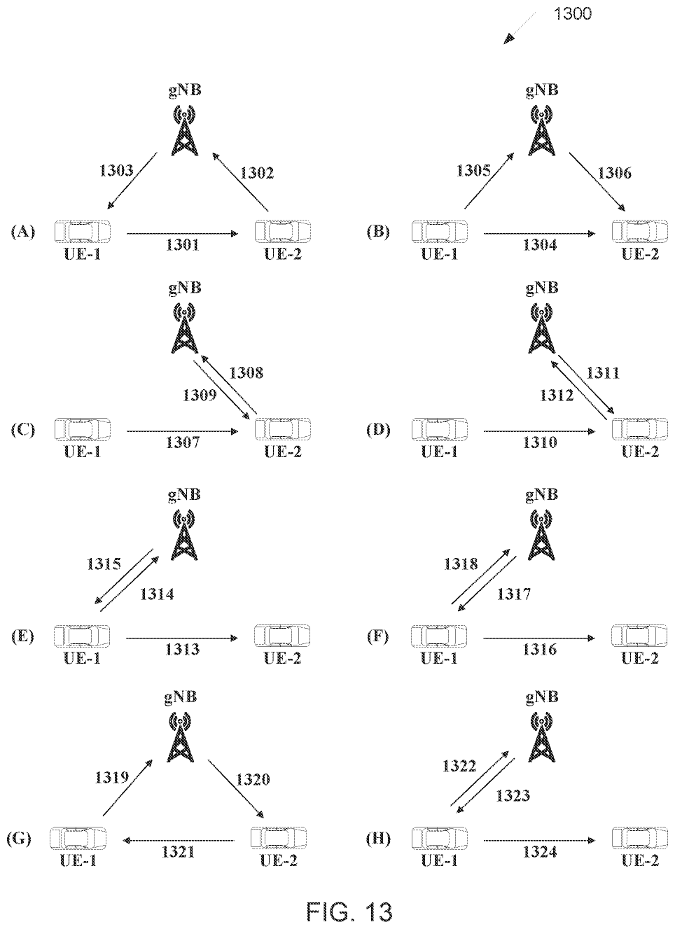

FIG. 13 illustrates an example of CO sharing among SL, UL, and DL 1300 according to various embodiments of the present disclosure. An embodiment of the CO sharing among SL, UL, and DL 1300 shown in FIG. 13 is for illustration only.

In one example, the UE-1 initializes the channel occupancy on sidelink and perform SL transmission(s) to a set of other UE(s) (e.g., UE-2) (e.g., 1301), and at least one UE in the set of other UE(s) (e.g., UE-2) shares the CO and performs UL transmission(s) to a gNB (e.g., 1302), and the gNB further shares the CO and performs DL transmission(s) to the UE initializing the CO (e.g., UE-1) (e.g., 1303). This example is shown in FIG. 13 (e.g., (A)).

In another example, the UE-1 initializes the channel occupancy and performs UL and SL transmission(s) to a gNB and a set of other UE(s) (e.g., UE-2) (e.g., 1304), respectively, wherein the UL and SL transmission(s) can be multiplexed into a burst (e.g., IFDMed, FDMed, TDMed, or CDMed) or multiplexed into multiple bursts, and the gNB shares the CO and perform DL transmission(s) to at least one UE in the set of other UE(s) (e.g., UE-2) (e.g., 1306). This example is shown in FIG. 13 (e.g., (B)).

In yet another example, the UE-1 initializes the channel occupancy and performs SL transmission(s) to a set of other UE(s) (e.g., UE-2) (e.g., 1307), and at least one UE in the set of other UE(s) (e.g., UE-2) shares the CO and performs UL transmission(s) to a gNB (e.g., 1308), and the gNB further shares the CO and performs DL transmission(s) to the at least one UE in the set of other UE(s) (e.g., UE-2) (e.g., 1309). This example is shown in FIG. 13 (e.g., (C)).

In yet another example, the UE-1 initializes the channel occupancy and performs SL transmission(s) to a set of other UE(s) (e.g., UE-2 (e.g., 1310), and a gNB shares the CO and performs DL transmission(s) to at least one UE in the set of other UE(s) (e.g., UE-2) (e.g., 1311), and the at least one UE in the set of other UE(s) (e.g., UE-2) further shares the CO and performs UL transmission(s) to the gNB (e.g., 1313). This example is shown in FIG. 13 (e.g., (D)).

In yet another example, the UE-1 initializes the channel occupancy and performs UL and SL transmission(s) to a gNB and a set of other UE(s) (e.g., UE-2) (e.g., 1313), respectively, wherein the UL and SL transmission(s) can be multiplexed into a burst (e.g., IFDMed, FDMed, TDMed, or CDMed) or multiplexed into multiple bursts, and the gNB shares the CO and perform DL transmission(s) to the UE initializing the CO (e.g., UE-1) (e.g., 1315). This example is shown in FIG. 13 (e.g., (E)).

In yet another example, the UE-1 initializes the channel occupancy and performs SL transmission(s) to a set of other UE(s) (e.g., UE-2) (e.g., 1316), and a gNB shares the CO and performs DL transmission(s) to the UE initializing the CO (e.g., UE-1) (e.g., 1317), and the UE initializing the CO (e.g., UE-1) further shares the CO and performs UL transmission(s) to the gNB (e.g., 1318). This example is shown in FIG. 13 (e.g., (F)).

In yet another example, the UE-1 initializes the channel occupancy and performs UL transmission(s) to a gNB, and the gNB shares the CO and performs DL transmission(s) to a set of other UE(s) (e.g., UE-2) (e.g., 1319), and at least one UE in the set of other UE(s) (e.g., UE-2) further shares the CO and performs SL transmission(s) to the UE initializing the CO (e.g., UE-1) (e.g., 1321). This example is shown in FIG. 13 (e.g., (G)).

In yet another example, the UE-1 initializes the channel occupancy and performs UL transmission(s) to a gNB (e.g., 1322), and the gNB shares the CO and performs DL transmission(s) to the UE initializing the CO (e.g., UE-1) (e.g., 1323), and the UE initializing the CO (e.g., UE-1) further shares the CO and performs SL transmission(s) to a set of other UE(s) (e.g., UE-2) (e.g., 1324). This example is shown in FIG. 13 (e.g., (H)).

In one example, the UE initializing the CO cannot continue to transmit after other UE or gNB shares the CO and transmits (e.g., there is at most one switching point from the UE-1 perspective).

In one sub-example, there is a further condition on the duration of the gap between the transmission bursts in the CO. For one instance, the duration of the gap cannot exceed a pre-defined threshold (e.g., 25 us).

In one example, the UE initializing the CO (e.g., UE-1) can continue to transmit after other UE or gNB shares the CO and transmits (e.g., no limitation on the number of switching points from UE-1 perspective).

In one sub-example, there is a further condition on the duration of the gap(s) between the transmission bursts in the CO. For one instance, the duration of any gap between transmission bursts cannot exceed a pre-defined threshold (e.g., 25 us).

In another sub-example, there is no condition on the duration of the gap(s) between the transmission bursts. For one instance, the duration of gap(s) is not counted into the channel occupancy time.

In one example, for this embodiment to be supported, there is a further condition on the UE(s). For instance, at least one of the UE initializing the CO (e.g., UE-1) or the set of other UE(s) (e.g., UE-2) is within the coverage of the gNB.

In one example, for this embodiment to be supported, there is a further condition on the UL/SL transmission(s) from UE-1. For one instance, at least one of the examples on UL/SL transmission burst described in this disclosure needs to be satisfied (e.g., Example UL-SL-Burst-1 to UL-SL-Burst-6), given the particular UE as one of the UE from the set of other UEs (e.g., UE-2) in the examples.

In another example, the this to be supported, there is a further condition on the UL/SL transmission(s) from the set of other UE(s) (e.g., UE-2). For one instance, at least one of the examples on UL/SL transmission burst described in this disclosure needs to be satisfied (e.g., Example UL-SL-Burst-1 to UL-SL-Burst-6), given the particular UE as the UE initializing the CO (e.g., UE-1).

In yet another example, for this embodiment to be supported, there is a further condition on the SL transmission(s) from UE-1. For one instance, at least one of the examples on SL transmission burst described in this disclosure needs to be satisfied (e.g., Example SL-Burst-1 to SL-Burst-6), given the particular UE as one of the UE from the set of other UEs (e.g., UE-2) in the examples.

In yet another example, for this embodiment to be supported, there is a further condition on the SL transmission(s) from UE-2. For one instance, at least one of the examples on SL transmission burst described in this disclosure needs to be satisfied (e.g., Example SL-Burst-1 to SL-Burst-6), given the particular UE as the UE initializing the CO (e.g., UE-1) in the examples.

In yet another example, for this embodiment to be supported, there is a further condition on the DL transmission(s). For one instance, the DL transmission may include non-unicast information and/or unicast information only to the UE(s) involved in the SL transmission(s) in the CO.

In yet another example, whether the CO initialized by the UE can be shared with other nodes can be configured by a higher layer parameter.

In yet another example, for this embodiment to be supported, there can be a further condition on the priority of SL transmission(s). For one instance, if the priority of the next intended SL transmission(s) is at least one of the same as or higher than the priority of the current SL transmission(s), the CO can be shared to the perform the next intended SL transmission.

In yet another example, whether the CO initialized by the UE can be shared with other nodes can be based on a further condition on the number or duration of failures in the channel access procedure. For one instance, if the number of failures in the channel access procedure exceeds a predefined threshold, the CO can be shared with other nodes after a successful channel access procedure. For another instance, if the duration of failures in the channel access procedure exceeds a predefined threshold, the CO can be shared with other nodes after a successful channel access procedure.

In yet another example, for the gap(s) when switching between transmission bursts, depending on the duration of the gap, the UE may perform SL transmission(s) after performing channel access procedure given by at least one of the examples described in this disclosure (e.g., Example SL-LBT-1 to SL-LBT-6), or perform UL transmission(s) after performing channel access procedure given by at least one of the examples described in this disclosure (e.g., Example UL-LBT-1 to UL-LBT-3), or perform DL transmission(s) after performing channel access procedure given by at least one of the examples described in this disclosure (e.g., Example DL-LBT-1 to DL-LBT-3).

In yet another example, for the gap(s) when switching between a UL/SL transmission and the previous transmission, depending on the duration of the gap, a sidelink UE may perform the UL/SL transmission after performing channel access procedure given by at least one of the examples described in this disclosure (e.g., Example UL-SL-LBT-1 to UL-SL-LBT-6).

In yet another example, if the SL energy detection threshold is not provided (e.g., configured by a higher layer parameter, and/or provided by a pre-configuration), at least one of the SL transmission(s) cannot include unicast transmission(s). For one instance, there is a further constraint on the duration of the SL transmission(s), e.g., no more than 2, 4, or 8 symbols for the SCS of SL BWP as 15, 30, or 60 kHz, respectively.

In yet another example, if the DL energy detection threshold is not provided (e.g., configured by a higher layer parameter, and/or provided by a pre-configuration), at least one of the DL transmission(s) cannot include unicast transmission(s). For one instance, there is a further constraint on the duration of the DL transmission(s), e.g., no more than 2, 4, or 8 symbols for the SCS of SL BWP as 15, 30, or 60 kHz, respectively.

In one embodiment, examples in this disclosure can be combined. For example, a UE can initialize a channel occupancy and perform at least one of uplink and/or sidelink transmission(s) and further shares the CO with a set of other UE(s) or gNB for transmission(s). The condition(s) associated with the embodiment(s) and the example(s) of the embodiment(s) in this disclosure can also be applicable when the examples are combined.

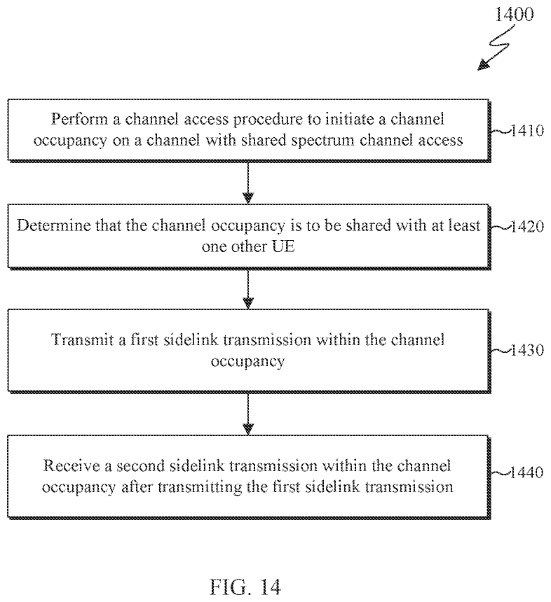

FIG. 14 illustrates an example method 1400 for UE channel occupancy sharing with a SL in a wireless communication system according to embodiments of the present disclosure. The steps of the method 1400 of FIG. 14 can be performed by any of the UEs 111-116 of FIG. 1, such as the UE 116 of FIG. 3. The method 1400 is for illustration only and other embodiments can be used without departing from the scope of the present disclosure.

The method 1400 begins with the UE performing a channel access procedure to initiate a channel occupancy on a channel with shared spectrum channel access (step 1405). For example, in step 1405, the channel access procedure to initiate the channel occupancy is a Type 1 sidelink channel access procedure and a time duration spanned by sensing slots that are sensed to be idle before a sidelink transmission is random. The UE then determines that the channel occupancy is to be shared with at least one other UE (step 1410).

The UE then transmits a first sidelink transmission within the channel occupancy (step 1415). For example, in step 1415, the first sidelink transmission is a PSSCH or a PSCCH conveying a unicast transmission to a first UE among the at least one other UE or a PSSCH or a PSCCH conveying a groupcast transmission to the at least one other UE.

The UE then receives a second sidelink transmission within the channel occupancy after transmitting the first sidelink transmission (step 1420). For example, in step 1420, the second sidelink transmission is within the channel occupancy and from the at least one other UE. In various embodiments, the second sidelink transmission is a PSSCH or a PSCCH conveying unicast transmission to the UE or a PSFCH transmitted to the UE.

In various embodiments, the UE may also determine a gap in time domain between the first sidelink transmission and the second sidelink transmission within the channel occupancy, determine a sidelink channel access procedure based on a duration of the gap, and indicate the sidelink channel access procedure to the at least one other UE. For example, the sidelink channel access procedure is Type 2A, when the duration of the gap is at least 25 us; the sidelink channel access procedure is Type 2B, when the duration of the gap is 16 us; and the sidelink channel access procedure is Type 2C, when the duration of the gap is less than 16 us. For example, when the sidelink channel access procedure is Type 2A, the second sidelink transmission may start immediately after sensing the channel to be idle for at least a sensing interval of 25 us; when the sidelink channel access procedure is Type 2B, the second sidelink transmission may start immediately after sensing the channel to be idle for at least a sensing interval of 16 us; and when the sidelink channel access procedure is Type 2C, the second sidelink transmission may start immediately without sensing the channel.

In various embodiments, the UE may transmit a third sidelink transmission within the channel occupancy after receiving the second sidelink transmission. For example, the third sidelink transmission is: a PSSCH or a PSCCH conveying a unicast transmission to a second UE among the at least one other UE; or a PSSCH or a PSCCH conveying a groupcast transmission to the at least one other UE. In various embodiments, the UE may determine a gap in time domain between the second sidelink transmission and a third sidelink transmission within the channel occupancy, determine a sidelink channel access procedure based on a duration of the gap, and performing the sidelink channel access procedure. For example, the sidelink channel access procedure is Type 2A, when the duration of the gap is at least 25 us; the sidelink channel access procedure is Type 2B, when the duration of the gap is 16 us; and the sidelink channel access procedure is Type 2C, when the duration of the gap is less than 16 us.

The above flowcharts and signaling flow diagrams illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A user equipment (UE) in a wireless communication system, the UE comprising:
a processor configured to:
perform a channel access procedure to initiate a channel occupancy on a channel with shared spectrum channel access; and
determine that the channel occupancy is to be shared with at least one other UE; and
a transceiver operably coupled to the processor, the transceiver configured to:
transmit a first sidelink transmission within the channel occupancy; and
receive, from the at least one other UE, a second sidelink transmission within the channel occupancy after transmitting the first sidelink transmission.

2. The UE of claim 1, wherein the second sidelink transmission is:
a physical sidelink shared channel (PSSCH) or a physical sidelink control channel (PSCCH) conveying a unicast transmission to the UE; or
a physical sidelink feedback channel (PSFCH) transmitted to the UE.

3. The UE of claim 1, wherein:
the channel access procedure to initiate the channel occupancy is a Type 1 sidelink channel access procedure, and
a time duration spanned by sensing slots that are sensed to be idle before a sidelink transmission is random.

4. The UE of claim 1, wherein:
the processor is further configured to determine:
a gap in time domain between the first sidelink transmission and the second sidelink transmission within the channel occupancy, and
based on a duration of the gap, a sidelink channel access procedure;
the sidelink channel access procedure is Type 2A, when the duration of the gap is at least 25 us;
the sidelink channel access procedure is Type 2B, when the duration of the gap is 16 us;
the sidelink channel access procedure is Type 2C, when the duration of the gap is less than 16 us; and
the transceiver is further configured to indicate the sidelink channel access procedure to the at least one other UE.

4. of claim 4, wherein:
when the sidelink channel access procedure is Type 2A, the second sidelink transmission starts immediately after sensing the channel to be idle for at least a sensing interval of 25 us;
when the sidelink channel access procedure is Type 2B, the second sidelink transmission starts immediately after sensing the channel to be idle for at least a sensing interval of 16 us; and
when the sidelink channel access procedure is Type 2C, the second sidelink transmission starts immediately without sensing the channel.

6. The UE of claim 1, wherein the first sidelink transmission is:
a physical sidelink shared channel (PSSCH) or a physical sidelink control channel (PSCCH) conveying a unicast transmission to a first UE among the at least one other UE; or
a PSSCH or a PSCCH conveying a groupcast transmission to the at least one other UE.

7. The UE of claim 6, wherein the transceiver is further configured to transmit a third sidelink transmission within the channel occupancy after receiving the second sidelink transmission.

8. The UE of claim 7, wherein:
the processor is further configured to determine:
a gap in time domain between the second sidelink transmission and the third sidelink transmission within the channel occupancy, and
based on a duration of the gap, a sidelink channel access procedure;
the sidelink channel access procedure is Type 2A, when the duration of the gap is at least 25 us;
the sidelink channel access procedure is Type 2B, when the duration of the gap is 16 us;
the sidelink channel access procedure is Type 2C, when the duration of the gap is less than 16 us; and
the transceiver is further configured to perform the sidelink channel access procedure.

9. The UE of claim 7, wherein the third sidelink transmission is:
a physical sidelink shared channel (PSSCH) or a physical sidelink control channel (PSCCH) conveying a unicast transmission to a second UE among the at least one other UE; or
a PSSCH or a PSCCH conveying a groupcast transmission to the at least one other UE.

10. The UE of claim 9, wherein the first UE is the second UE.

11. A method of a user equipment (UE) in a wireless communication system, the method comprising:
performing a channel access procedure to initiate a channel occupancy on a channel with shared spectrum channel access;
determining that the channel occupancy is to be shared with at least one other UE;
transmitting a first sidelink transmission within the channel occupancy; and
receiving, from the at least one other UE, a second sidelink transmission within the channel occupancy after transmitting the first sidelink transmission within the channel occupancy.

12. The method of claim 11, wherein the second sidelink transmission is:
a physical sidelink shared channel (PSSCH) or a physical sidelink control channel (PSCCH) conveying a unicast transmission to the UE; or
a physical sidelink feedback channel (PSFCH) transmitted to the UE.

13. The method of claim 11, wherein:
the channel access procedure to initiate the channel occupancy is a Type 1 sidelink channel access procedure, and
a time duration spanned by sensing slots that are sensed to be idle before a sidelink transmission is random.

14. The method of claim 11 further comprising:
determining a gap in time domain between the first sidelink transmission and the second sidelink transmission within the channel occupancy;
determining a sidelink channel access procedure based on a duration of the gap, wherein:
the sidelink channel access procedure is Type 2A, when the duration of the gap is at least 25 us;
the sidelink channel access procedure is Type 2B, when the duration of the gap is 16 us; and
the sidelink channel access procedure is Type 2C, when the duration of the gap is less than 16 us; and
indicating the sidelink channel access procedure to the at least one other UE.

15. The method of claim 14, wherein:
when the sidelink channel access procedure is Type 2A, the second sidelink transmission starts immediately after sensing the channel to be idle for at least a sensing interval of 25 us;
when the sidelink channel access procedure is Type 2B, the second sidelink transmission starts immediately after sensing the channel to be idle for at least a sensing interval of 16 us; and
when the sidelink channel access procedure is Type 2C, the second sidelink transmission starts immediately without sensing the channel.

16. The method of claim 11, wherein the first sidelink transmission is:
a physical sidelink shared channel (PSSCH) or a physical sidelink control channel (PSCCH) conveying unicast transmission to a first UE among the at least one other UE; or
a PSSCH or a PSCCH conveying a groupcast transmission to the at least one other UE.

17. The method of claim 16, further comprising:
transmitting a third sidelink transmission within the channel occupancy after receiving the second sidelink transmission.

18. The method of claim 17, further comprising:
determining a gap in time domain between the second sidelink transmission and the third sidelink transmission within the channel occupancy;
determining a sidelink channel access procedure based on a duration of the gap, wherein:
the sidelink channel access procedure is Type 2A, when the duration of the gap is at least 25 us;
the sidelink channel access procedure is Type 2B, when the duration of the gap is 16 us; and
the sidelink channel access procedure is Type 2C, when the duration of the gap is less than 16 us; and
performing the sidelink channel access procedure.

19. The method of claim 17, wherein the third sidelink transmission is:
a physical sidelink shared channel (PSSCH) or a physical sidelink control channel (PSCCH) conveying a unicast transmission to a second UE among the at least one other UE; or
a PSSCH or a PSCCH conveying a groupcast transmission to the at least one other UE.

19. od of claim 19, wherein the first UE is the second UE.
